(19) United States
(12) Patent Application Publication
(10) Pub. No.: US 2025/0028052 A1
(43) Pub. Date: Jan. 23, 2025

(54) MEASURING THE POSITION OF A MIRROR SURFACE IN POINT CLOUDS CAPTURED BY A SCANNER

(71) Applicant: FARO Technologies, Inc., Lake Mary, FL (US)

(72) Inventors: Ludwig Klam, Weissach im Tal (DE); Konstantin Heil, Korntal-Münchingen (DE)

(21) Appl. No.: 18/778,334

(22) Filed: Jul. 19, 2024

Related U.S. Application Data
(60) Provisional application No. 63/528,065, filed on Jul. 20, 2023.

(51) Int. Cl. G01S 17/894; G01S 7/481

(52) U.S. Cl. CPC G01S 17/894; G01S 7/4817

(57) ABSTRACT

Embodiments for measuring/determining the position and shape of a mirror surface in 3D point clouds are provided given the knowledge of the position from where the points of the point cloud were captured. Starting from an initial rough estimation of a modelled mirror surface, the point cloud is divided into two parts: the presumable virtual points that are behind the modelled mirror with respect to the scanner position and the rest or remainder of the points in the point cloud. The presumable virtual points are mirrored back at the modelled mirror surface and then registered against the rest of the point cloud. The registered points cleaned from outliers together with the associated virtual points define the actual position and shape of the mirror surface.

### BACKGROUND

The subject matter disclosed herein relates to use of a three-dimensional (“3D”) measurement device, such as a laser scanner time-of-flight (TOF) coordinate measurement device. A 3D laser scanner of this type steers a beam of light to a non-cooperative target such as a diffusely scattering surface of an object. A distance meter in the device measures a distance to the object, and angular encoders measure the angles of rotation of two axles in the device. The measured distance and two angles enable a processor in the device to determine the 3D coordinates of the target.

A time-of-flight (TOF) laser scanner is a scanner in which the distance to a target point is determined based on the speed of light in air between the scanner and a target point. Laser scanners are typically used for scanning closed or open spaces such as interior areas of buildings, industrial installations and tunnels. They are used, for example, in industrial applications and accident reconstruction applications. A laser scanner optically scans and measures objects in a volume around the scanner through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, stored and sent to a processor or processors to generate a 3D image representing the scanned area or object.

Generating an image requires at least three values for each data point. These three values include the distance and two angles, or transformed values, such as the x, y, z coordinates.

Most TOF scanners direct the beam of light within the measurement volume by steering the light with a beam steering mechanism. The beam steering mechanism includes a first motor that steers the beam of light about a first axis by a first angle that is measured by a first angular encoder (or other angle transducer). The beam steering mechanism also includes a second motor that steers the beam of light about a second axis by a second angle that is measured by a second angular encoder (or other angle transducer). As a result of the scan, for each pair of azimuthal and zenith angle a distance measurement is recorded for points on surfaces in the environment. These distance measurements are converted into a collection of 3D coordinates together with a reference point for the origin of the measurement (scanner location). This collection of 3D coordinates is sometimes referred to as a “point cloud.” In many applications, multiple scans are performed in an environment to acquire the desired measurements.

Many contemporary laser scanners include a camera mounted on the laser scanner for gathering camera digital images of the environment and for presenting the camera digital images to an operator of the laser scanner. By viewing the camera images, the operator of the scanner determines the field of view of the measured volume and adjust settings on the laser scanner to measure over a larger or smaller region of space. In addition, the digital camera images are transmitted to a processor to add color to the scanner image. To generate a color scanner image, at least three positional coordinates (such as x, y, z) and three color values (such as red, green, blue “RGB”) are collected for each data point.

The scanner acquires 3D data points only on surfaces that backscatter the laser beam diffusely into the sensor of the TOF scanner. When the laser beam hits reflecting surfaces, it is deflected until it reaches a diffusely scattering surface. From such a diffusely scattering surface, the light is scattered back to the sensor of the scanner in the opposite direction on the same path through all reflecting surfaces. As consequence, 3D points cannot be measured on reflecting surfaces. Instead, virtual points will be recorded behind the reflecting surface. What is a reflective surface depends on the wavelength of the used laser beam. Typical examples are mirrors and windows.

The virtual points in the resulting point cloud are considered as artifacts, since they disturb the registration between different point clouds and create a bad visual impression. Removing artifacts from the point cloud is usually performed in a manual operation. Having individuals correct the resulting point cloud is therefore tedious and time consuming.

Accordingly, while existing 3D scanners and image processing techniques are suitable for their intended purposes, what is needed is further image processing having certain features of embodiments described herein.

### BRIEF SUMMARY OF THE INVENTION

According to one or more embodiments, a computer-implemented method is provided. The computer-implemented method requires a (3D) point cloud, the knowledge of the scanner position from which the point cloud was captured, and an initial guess about the location of a reflective surface within the point cloud. From the scanner position and the initial guess about the location of a reflective surface, the point cloud is divided into two parts: (i) the presumable virtual points that are located behind the reflective surface with respect to the scanner position, and (ii) the rest (remainder) of the points in the point cloud. The points identified as (i) are then registered after a mirror operation to the rest of the points (ii). The accurate position and orientation of the reflective surface is determined by the transformation obtained from the registration. The extent and shape of the reflective surface within the 3D point cloud is approximated by the subset of points adjusted for outliers with the best registration result.

These and other advantages and features will become more apparent from the following description taken in conjunction with the drawings.

### BRIEF DESCRIPTION OF THE DRAWINGS

The foregoing and other features, and advantages of the invention are apparent from the following detailed description taken in conjunction with the accompanying drawings in which:

FIG. 1 is a perspective view of a laser scanner in accordance with an embodiment of the invention;

FIG. 2 is a side view of the laser scanner illustrating a method of measurement according to an embodiment;

FIG. 3 is a schematic illustration of the optical, mechanical, and electrical components of the laser scanner according to an embodiment;

FIG. 4 is a schematic illustration of the laser scanner of FIG. 1 according to an embodiment;

FIG. 5 is a block diagram of an example computer system for use in conjunction with one or more embodiments;

FIG. 6 is a block diagram of a computer system for automatically removing reflection artifacts from a three-dimensional (3D) image according to one or more embodiments;

FIG. 7 is a flowchart of a computer-implemented method for training an artificial intelligence (AI) model for detecting and generating a bounding box around reflective surfaces according to one or more embodiments;

FIG. 8 is a flowchart of a computer-implemented method for automatic coarse identification of mirroring surfaces in 3D images according to one or more embodiments;

FIG. 9 illustrates an example color image having reflective surfaces labeled with a bounding box according to one or more embodiments;

FIG. 10 illustrates an example color image having reflective surfaces labeled with a bounding box according to one or more embodiments;

FIG. 11 illustrates an example of a color image and its intensity information (e.g., a grayscale/reflectance image) input to the AI model which is used to generate bounding boxes in the color image according to one or more embodiments;

FIG. 12 illustrates an example reflectance image highlighting a bounding box encompassing a window according to one or more embodiments;

FIG. 13A illustrates that reflection points or artifacts are identified for removal from the window in FIG. 12 according to one or more embodiments;

FIG. 13B illustrates that the identified reflection points or artifacts in FIG. 13A are removed from the 3D point cloud according to one or more embodiments;

FIG. 14 depicts a flowchart of a computer-implemented method for measuring/determining the exact position of a mirror surface within a point cloud from an initial estimation to one or more embodiments;

FIGS. 15A, 15B, and 15C depict a 2D point cloud illustrating different states of the flowchart of FIG. 14 according to one or more embodiments;

FIG. 16 depicts a 3D point cloud as measured from a TOF scanner, which has been processed in accordance with the flowchart of FIG. 14, according to one or more embodiments;

FIG. 17 depicts a flowchart of a computer-implemented method for measuring/determining the position of a mirror surface in a 3D point cloud and adding mirrored points, having been mirrored from virtual points, back into the 3D point cloud according to one or more embodiments;

FIG. 18A illustrates an example of how to construct the real point Vᵢ′ from the scanner location Oᵢ and a measured virtual point Vᵢ through a curved mirror surface according to one or more embodiments; and

FIG. 18B illustrates an example of how to construct the point Mᵢ on the mirror surface from the scanner location Oᵢ, the measured virtual point Vᵢ and the corresponding real point Vᵢ″ according to one or more embodiments.

The detailed description explains embodiments of the invention, together with advantages and features, by way of example with reference to the drawings.

### DETAILED DESCRIPTION

One or more embodiments of the present disclosure relate to measuring the position of a mirror surface in 3D point clouds captured for example by a laser scanner. Whether a surface is mirror-like depends amongst other variables on the wavelength of the laser beam used by the laser scanner. Typical examples for mirror surfaces are mirrors and windows. In accordance with one or more embodiments, the exact position including the surface orientation, the extent or extension (e.g., width/height) of the mirror surface, and the curvature of the mirror surface are determined within the 3D point cloud of the scans. According to one or more embodiments, starting from a rough estimation of the mirror surface position, the exact position is reconstructed by identifying the mirrored points within the point cloud itself. This could be performed by an iterative approach that separates the mirrored points from the rest of the point cloud and where both point clouds are registered against each other.

Mirrors and windows lead to artifacts in scans captured by the laser scanner. The resulting point clouds contain additional points from the mirrored objects at a wrong position. These reflections are unwanted, disturb the registration, and provide an undesired visual impression. Identifying these reflections is a difficult problem because the presence of the reflections depends on the exact location and geometry of the mirroring surface which is invisible in the recorded 3D point cloud. For planar mirrors, the reflected points from an object are defined exclusively by the object coordinates and the mirror plane. Just the visibility of the reflected points is determined by the location from where the 3D points have been recorded (scanner position). For curved mirrors, the position of reflected points depends, in addition, strongly on the scanner position, in accordance with one or more embodiments. In both cases (planar and curved mirror), the knowledge of the scanner position and the knowledge of the exact geometry and position of the mirroring surface are typically sufficient to identify the reflections as all points laying behind the mirroring surface with respect to the scanner position. In other words, the ray from the scanner position to the reflected point intersects the mirror surface.

State-of-the-art approaches aim to remove artifacts that are created by mirror surfaces. However, instead of removing all of these reflected 3D points, at least some of these 3D points are used to measure and identify the mirror surface itself according to one or more embodiments. The actual 3D point coordinates corresponding to the reflected points are determined from a successful self-registration of the mirrored points to their counterparts in the 3D point cloud in accordance with one or more embodiments. The position, orientation, and curvature of the mirroring surface are determined by the laws of reflection from the reflected points, their corresponding 3D points, and the position from where the points where recorded. Additionally, the self-registration allows embodiments to add the mirrored points back into the 3D point cloud in various embodiments.

Technical solutions, effects, and benefits described herein determine the mirror plane (position and geometry), remove disturbing reflections, and increase point density for objects scanned through the mirror by adding these points back to the scene (of the 3D point cloud), thereby resulting in a 3D point cloud enhanced with the mirrored points, free of reflection artifacts, and with the knowledge about the exact position of the mirror surface.

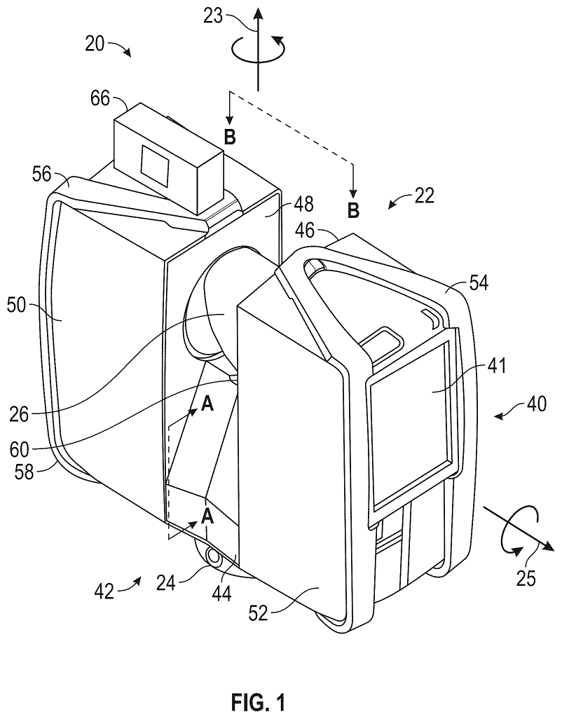

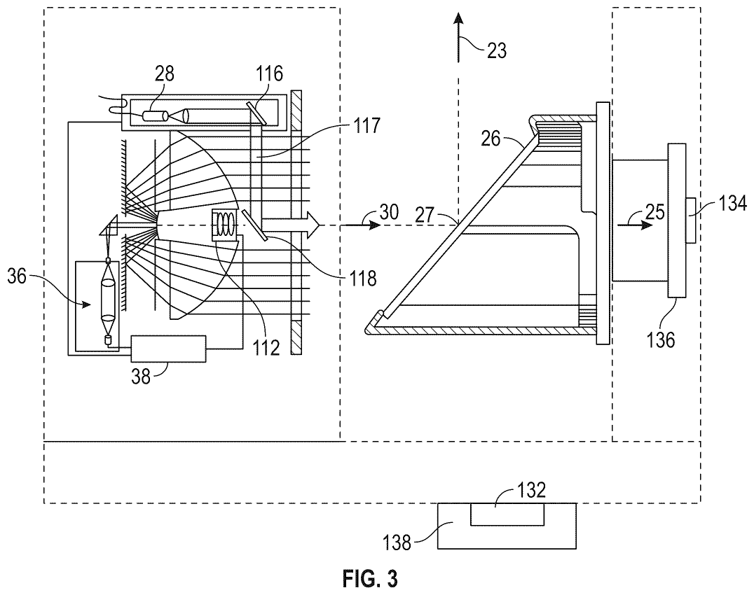

Referring now to FIGS. 1-3, a coordinate measurement device, such as a laser scanner 20, is depicted for optically scanning and measuring the environment surrounding the laser scanner 20. The laser scanner 20 has a measuring head 22 and a base 24. The measuring head 22 is mounted on the base 24 such that the laser scanner 20 is rotated about a vertical axis 23. In one embodiment, the measuring head 22 includes a gimbal point 27 that is a center of rotation about the vertical axis 23 and a horizontal axis 25. The measuring head 22 has a rotary mirror 26, which is rotated about the horizontal axis 25. The rotation about the vertical axis is about the center of the base 24. The terms vertical axis and horizontal axis refer to the scanner in its normal upright position. It is possible to operate a 3D coordinate measurement device on its side or upside down, and so to avoid confusion, the terms “azimuth axis” and “zenith axis” are substituted for the terms “vertical axis” and “horizontal axis,” respectively and the terms “pan axis” or “standing axis” are used as an alternative to “vertical axis.”

The measuring head 22 is further provided with an electromagnetic radiation emitter, such as light emitter 28, for example, that emits an emitted light beam 30. In one embodiment, the emitted light beam 30 is a coherent light beam such as a laser beam. The laser beam has a wavelength range of approximately 300 to 1600 nanometers, for example 790 nanometers, 905 nanometers, 1550 nm, or less than 400 nanometers. It should be appreciated that, in various embodiments, other electromagnetic radiation beams having greater or smaller wavelengths are used. The emitted light beam 30 is amplitude or intensity modulated, for example, with a sinusoidal waveform or with a rectangular waveform. The light beam 30 is emitted by the light emitter 28 onto a beam steering unit, such as mirror 26, where it is deflected to the environment. A reflected light beam 32 is reflected from the environment by an object 34. The reflected or scattered light is intercepted by the rotary mirror 26 and directed into a light receiver 36. The directions of the emitted light beam 30 and the reflected light beam 32 result from the angular positions of the rotary mirror 26 and the measuring head 22 about the axes 25 and 23, respectively. These angular positions in turn depend on the corresponding rotary drives or motors.

Coupled to the light emitter 28 and the light receiver 36 is a controller 38. The controller 38 determines, for a multitude of measuring points X, a corresponding number of distances d between the laser scanner 20 and the points X on object 34. The distance d to a particular point X is determined based at least in part on the speed of light in air through which electromagnetic radiation propagates from the device to the object point X. In one embodiment the phase shift of modulation in light emitted by the laser scanner 20 and the point X is determined and evaluated to obtain a measured distance d.

The speed of light in air depends on the properties of the air such as the air temperature, barometric pressure, relative humidity, and concentration of carbon dioxide. Such air properties influence the index of refraction n of the air. The speed of light in air is equal to the speed of light in vacuum c divided by the index of refraction. In other words, cₐᵢᵣ=c/n. A laser scanner of the type discussed herein is based on the time-of-flight (TOF) of the light in the air (the round-trip time for the light to travel from the device to the object and back to the device). Examples of TOF scanners include scanners that measure round trip time using the time interval between emitted and returning pulses (pulsed TOF scanners), scanners that modulate light sinusoidally and measure phase shift of the returning light (phase-based scanners), as well as many other types. A method of measuring distance based on the time-of-flight of light depends on the speed of light in air and is therefore easily distinguished from methods of measuring distance based on triangulation. Triangulation-based methods involve projecting light from a light source along a particular direction and then intercepting the light on a camera pixel along a particular direction. By knowing the distance between the camera and the projector and by matching a projected angle with a received angle, the method of triangulation enables the distance to the object to be determined based on one known length and two known angles of a triangle. The method of triangulation, therefore, does not directly depend on the speed of light in air.

In one mode of operation, the scanning of the volume around the laser scanner 20 takes place by rotating the rotary mirror 26 relatively quickly about axis 25 while rotating the measuring head 22 relatively slowly about axis 23, thereby moving the assembly in a spiral pattern. In an exemplary embodiment, the rotary mirror rotates at a maximum speed of 5820 revolutions per minute. For such a scan, a gimbal point 27 defines the origin of the local stationary reference system. The base 24 rests in this local stationary reference system.

In addition to measuring a distance d from the gimbal point 27 to an object point X, the scanner 20 collects gray-scale information related to the received optical power (equivalent to the term “brightness”). The gray-scale value is determined at least in part, for example, by integration of the bandpass-filtered and amplified signal in the light receiver 36 over a measuring period attributed to the object point X.

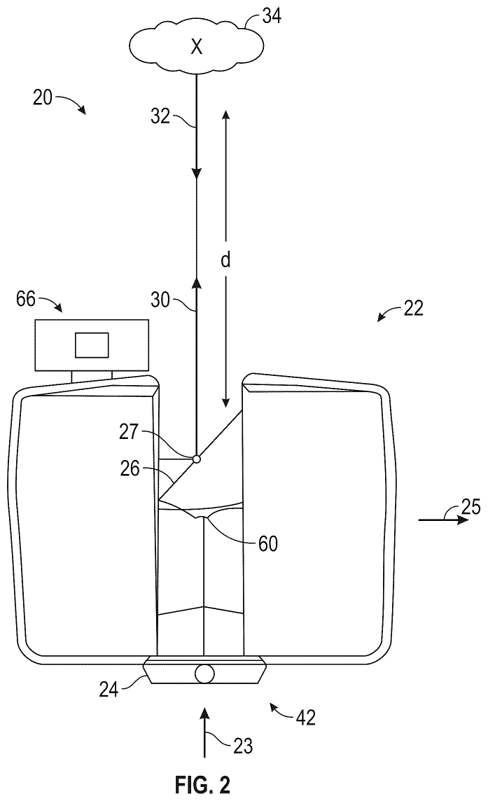

The measuring head 22 includes a display device 40 integrated into the laser scanner 20. The display device 40 includes a graphical touch screen 41, as shown in FIG. 2A, which allows the operator to set the parameters or initiate the operation of the laser scanner 20. For example, the screen 41 has a user interface that allows the operator to provide measurement instructions to the device, and the screen has a display with measurement results.

The laser scanner 20 includes a carrying structure 42 that provides a frame for the measuring head 22 and a platform for attaching the components of the laser scanner 20. In one embodiment, the carrying structure 42 is made from a metal such as aluminum. The carrying structure 42 includes a traverse member 44 having a pair of walls 46, 48 on opposing ends. The walls 46, 48 are parallel to each other and extend in a direction opposite the base 24. Shells 50, 52 are coupled to the walls 46, 48 and cover the components of the laser scanner 20. In the exemplary embodiment, the shells 50, 52 are made from a plastic material, such as polycarbonate or polyethylene for example. The shells 50, 52 cooperate with the walls 46, 48 to form a housing for the laser scanner 20.

On an end of the shells 50, 52 opposite the walls 46, 48 a pair of yokes 54, 56 are arranged to partially cover the respective shells 50, 52. In the exemplary embodiment, the yokes 54, 56 are made from a suitably durable material, such as aluminum for example, that assists in protecting the shells 50, 52 during transport and operation. The yokes 54, 56 each includes a first arm portion 58 that is coupled, such as with a fastener for example, to the traverse 44 adjacent the base 24. The arm portion 58 for each yoke 54, 56 extends from the traverse 44 obliquely to an outer corner of the respective shell 50, 52. From the outer corner of the shell, the yokes 54, 56 extend along the side edge of the shell to an opposite outer corner of the shell. Each yoke 54, 56 further includes a second arm portion that extends obliquely to the walls 46, 48. It should be appreciated that the yokes 54, 56 is coupled to the traverse 42, the walls 46, 48 and the shells 50, 54 at multiple locations.

The pair of yokes 54, 56 cooperate to circumscribe a convex space within which the two shells 50, 52 are arranged. In the exemplary embodiment, the yokes 54, 56 cooperate to cover all of the outer edges of the shells 50, 54, while the top and bottom arm portions project over at least a portion of the top and bottom edges of the shells 50, 52. This provides advantages in protecting the shells 50, 52 and the measuring head 22 from damage during transportation and operation. In other embodiments, the yokes 54, 56 includes additional features, such as handles to facilitate the carrying of the laser scanner 20 or attachment points for accessories for example.

On top of the traverse 44, a prism 60 is provided. The prism extends parallel to the walls 46, 48. In the exemplary embodiment, the prism 60 is integrally formed as part of the carrying structure 42. In other embodiments, the prism 60 is a separate component that is coupled to the traverse 44. When the mirror 26 rotates, during each rotation the mirror 26 directs the emitted light beam 30 onto the traverse 44 and the prism 60. Due to non-linearities in the electronic components, for example in the light receiver 36, the measured distances d depends on signal strength, which is measured in optical power entering the scanner or optical power entering optical detectors within the light receiver 36, for example. In an embodiment, a distance correction is stored in the scanner as a function (possibly a nonlinear function) of distance to a measured point and optical power (generally unscaled quantity of light power sometimes referred to as “brightness”) returned from the measured point and sent to an optical detector in the light receiver 36. Since the prism 60 is at a known distance from the gimbal point 27, the measured optical power level of light reflected by the prism 60 is used to correct distance measurements for other measured points, thereby allowing for compensation to correct for the effects of environmental variables such as temperature. In the exemplary embodiment, the resulting correction of distance is performed by the controller 38.

In an embodiment, the base 24 is coupled to a swivel assembly (not shown) such as that described in commonly owned U.S. Pat. No. 8,705,012, which is incorporated by reference herein. The swivel assembly is housed within the carrying structure 42 and includes a motor 138 that is configured to rotate the measuring head 22 about the axis 23. In an embodiment, the angular/rotational position of the measuring head 22 about the axis 23 is measured by angular encoder 134.

An auxiliary image acquisition device 66 is a device that captures and measures a parameter associated with the scanned area or the scanned object and provides a signal representing the measured quantities over an image acquisition area. The auxiliary image acquisition device 66 is not limited to, a pyrometer, a thermal imager, an ionizing radiation detector, or a millimeter-wave detector. In an embodiment, the auxiliary image acquisition device 66 is a color camera.

In an embodiment, a central color camera (first image acquisition device) 112 is located internally to the scanner and has the same optical axis as the 3D scanner device. In this embodiment, the first image acquisition device 112 is integrated into the measuring head 22 and arranged to acquire images along the same optical pathway as emitted light beam 30 and reflected light beam 32. In this embodiment, the light from the light emitter 28 reflects off a fixed mirror 116 and travels to dichroic beam-splitter 118 that reflects the light 117 from the light emitter 28 onto the rotary mirror 26. In an embodiment, the mirror 26 is rotated by a motor 136 and the angular/rotational position of the mirror is measured by angular encoder 134. The dichroic beam-splitter 118 allows light to pass through at wavelengths different than the wavelength of light 117. For example, the light emitter 28 is a near infrared laser light (for example, light at wavelengths of 780 nm or 1150 nm), with the dichroic beam-splitter 118 configured to reflect the infrared laser light while allowing visible light (e.g., wavelengths of 400 to 700 nm) to transmit through. In other embodiments, the determination of whether the light passes through the beam-splitter 118 or is reflected depends on the polarization of the light. The digital camera 112 obtains 2D images of the scanned area to capture color data to add to the scanned image. In the case of a built-in color camera having an optical axis coincident with that of the 3D scanning device, the direction of the camera view is easily obtained by simply adjusting the steering mechanisms of the scanner—for example, by adjusting the azimuth angle about the axis 23 and by steering the mirror 26 about the axis 25.

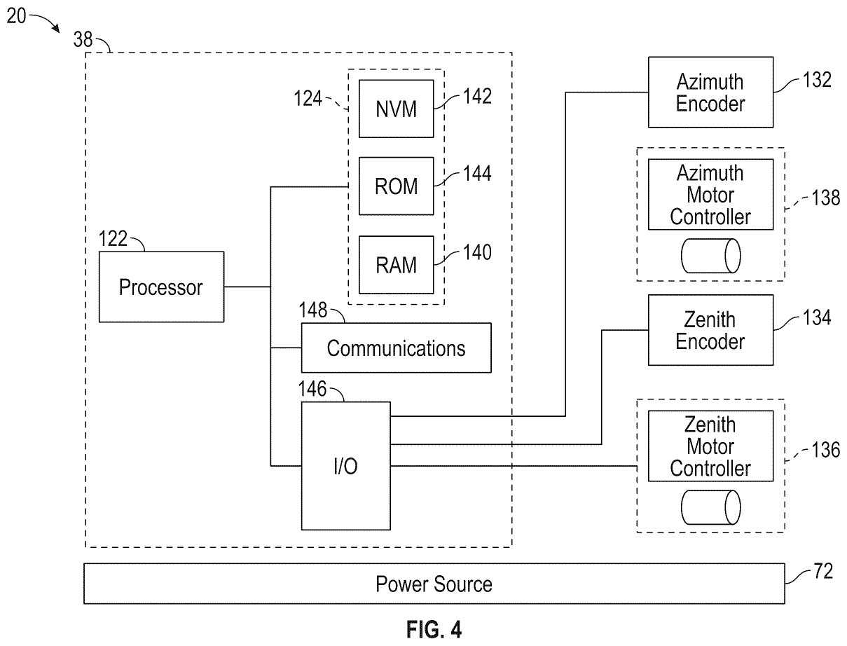

Referring now to FIG. 4 with continuing reference to FIGS. 1-3, elements are shown of the laser scanner 20. Controller 38 is a suitable electronic device capable of accepting data and instructions, executing the instructions to process the data, and presenting the results. The controller 38 includes one or more processing elements 122. The processors is microprocessors, field programmable gate arrays (FPGAs), digital signal processors (DSPs), and generally any device capable of performing computing functions. The one or more processors 122 have access to memory 124 for storing information.

Controller 38 is capable of converting the analog voltage or current level provided by light receiver 36 into a digital signal to determine a distance from the laser scanner 20 to an object in the environment. Controller 38 uses the digital signals that act as input to various processes for controlling the laser scanner 20. The digital signals represent one or more laser scanner 20 data including but not limited to distance to an object, images of the environment, images acquired by panoramic camera 126, angular/rotational measurements by a first or azimuth encoder 132, and angular/rotational measurements by a second axis or zenith encoder 134.

In general, controller 38 accepts data from encoders 132, 134, light receiver 36, light source 28, and panoramic camera 126 and is given certain instructions for the purpose of generating a 3D point cloud of a scanned environment. Controller 38 provides operating signals to the light source 28, light receiver 36, panoramic camera 126, zenith motor 136 and azimuth motor 138. The controller 38 compares the operational parameters to predetermined variances and if the predetermined variance is exceeded, generates a signal that alerts an operator to a condition. The data received by the controller 38 is displayed on a user interface 40 coupled to controller 38. The user interface 40 is one or more LEDs (light-emitting diodes), an LCD (liquid-crystal diode) display, a CRT (cathode ray tube) display, a touch-screen display or the like. A keypad is coupled to the user interface for providing data input to controller 38. In one embodiment, the user interface is arranged or executed on a mobile computing device that is coupled for communication, such as via a wired or wireless communications medium (e.g., Ethernet, serial, USB, BLUETOOTH or WiFi) for example, to the laser scanner 20.

The controller 38 is coupled to external computer networks such as a local area network (LAN) and the Internet. A LAN interconnects one or more remote computers, which are configured to communicate with controller 38 using a well-known computer communications protocol such as TCP/IP (Transmission Control Protocol/Internet Protocol), RS-232, ModBus, and the like. Additional systems is connected to LAN with the controllers 38 in each of these systems being configured to send and receive data to and from remote computers and other systems. The LAN is connected to the Internet. This connection allows controller 38 to communicate with one or more remote computers connected to the Internet.

The processors 122 are coupled to memory 124. The memory 124 includes random access memory (RAM) device 140, a non-volatile memory (NVM) device 142, and a read-only memory (ROM) device 144. In addition, the processors 122 is connected to one or more input/output (I/O) controllers 146 and a communications circuit 148. In an embodiment, the communications circuit 148 provides an interface that allows wireless or wired communication with one or more external devices or networks, such as the LAN discussed above.

Controller 38 includes operation control methods embodied in application code. These methods are embodied in computer instructions written to be executed by processors 122, typically in the form of software. The software is encoded in any language, including, but not limited to, assembly language, VHDL (Verilog Hardware Description Language), VHSIC HDL (Very High Speed IC Hardware Description Language), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing.

It should be appreciated that while some embodiments herein describe a point cloud that is generated by a TOF scanner, this is for example purposes and the claims should not be so limited. In other embodiments, the point cloud is generated or created using other types of scanners, such as but not limited to triangulation scanners, area scanners, structured-light scanners, laser line scanners, flying dot scanners, and photogrammetry devices for example.

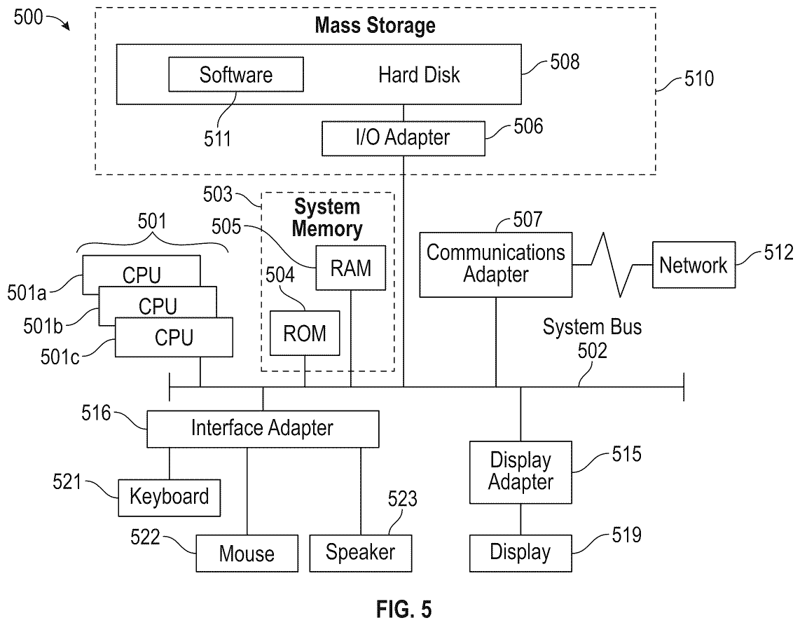

Turning now to FIG. 5, a computer system 500 is generally shown in accordance with one or more embodiments. The computer system 500 is an electronic, computer framework comprising and/or employing any number and combination of computing devices and networks utilizing various communication technologies, as described herein. The computer system 500 is easily scalable, extensible, and modular, with the ability to change to different services or reconfigure some features independently of others. The computer system 500 is, for example, a server, desktop computer, laptop computer, tablet computer, or smartphone. In some examples, computer system 500 is a cloud computing node. Computer system 500 is described in the general context of computer system executable instructions, such as program modules, being executed by a computer system. Generally, program modules include routines, programs, objects, components, logic, data structures, and so on that perform particular tasks or implement particular abstract data types. Computer system 500 is practiced in distributed cloud computing environments where tasks are performed by remote processing devices that are linked through a communications network. In a distributed cloud computing environment, program modules are located in both local and remote computer system storage media including memory storage devices.

As shown in FIG. 5, the computer system 500 has one or more central processing units (CPU(s)) 501a, 501b, 501c, etc., (collectively or generically referred to as processor(s) 501). The processors 501 is a single-core processor, multi-core processor, computing cluster, or any number of other configurations. The processors 501, also referred to as processing circuits, are coupled via a system bus 502 to a system memory 503 and various other components. The system memory 503 includes a read only memory (ROM) 504 and a random access memory (RAM) 505. The ROM 504 is coupled to the system bus 502 and includes a basic input/output system (BIOS) or its successors like Unified Extensible Firmware Interface (UEFI), which controls certain basic functions of the computer system 500. The RAM is read-write memory coupled to the system bus 502 for use by the processors 501. The system memory 503 provides temporary memory space for operations of said instructions during operation. The system memory 503 includes random access memory (RAM), read only memory, flash memory, or any other suitable memory systems.

The computer system 500 comprises an input/output (I/O) adapter 506 and a communications adapter 507 coupled to the system bus 502. The I/O adapter 506 is a small computer system interface (SCSI) adapter that communicates with a hard disk 508 and/or any other similar component. The I/O adapter 506 and the hard disk 508 are collectively referred to herein as a mass storage 510.

Software 511 for execution on the computer system 500 is stored in the mass storage 510. The mass storage 510 is an example of a tangible storage medium readable by the processors 501, where the software 511 is stored as instructions for execution by the processors 501 to cause the computer system 500 to operate, such as is described herein below with respect to the various Figures. Examples of computer program products and the execution of such instruction are discussed herein in more detail. The communications adapter 507 interconnects the system bus 502 with a network 512, which is an outside network, enabling the computer system 500 to communicate with other such systems. In one embodiment, a portion of the system memory 503 and the mass storage 510 collectively store an operating system, which is any appropriate operating system to coordinate the functions of the various components shown in FIG. 5.

Additional input/output devices are shown as connected to the system bus 502 via a display adapter 515 and an interface adapter 516. In one embodiment, the adapters 506, 507, 515, and 516 is connected to one or more I/O buses that are connected to the system bus 502 via an intermediate bus bridge (not shown). A display 519 (e.g., a screen or a display monitor) is connected to the system bus 502 by the display adapter 515, which includes a graphics controller to improve the performance of graphics intensive applications and a video controller. A keyboard 521, a mouse 522, a speaker 523, etc., are interconnected to the system bus 502 via the interface adapter 516, which includes, for example, a Super I/O chip integrating multiple device adapters into a single integrated circuit. Suitable I/O buses for connecting peripheral devices such as hard disk controllers, network adapters, and graphics adapters typically include common protocols, such as Peripheral Component Interconnect (PCI) and the Peripheral Component Interconnect Express (PCIe). Thus, as configured in FIG. 5, the computer system 500 includes processing capability in the form of the processors 501, storage capability including the system memory 503 and the mass storage 510, input devices such as the keyboard 521 and the mouse 522, and output capability including the speaker 523 and the display 519.

In some embodiments, the communications adapter 507 transmits data using any suitable interface or protocol, such as the internet small computer system interface, among others. The network 512 is a cellular network, a radio network, a wide area network (WAN), a local area network (LAN), or the Internet, or other useful computing networks, in various embodiments. An external computing device connects to the computer system 500 through the network 512. In some examples, an external computing device is an external webserver or a cloud computing node.

It is to be understood that the block diagram of FIG. 5 is not intended to indicate that the computer system 500 includes all of the components shown in FIG. 5. Rather, in various embodiments, the computer system 500 includes any appropriate fewer or additional components not illustrated in FIG. 5 (e.g., additional memory components, embedded controllers, modules, additional network interfaces, etc.). Further, the embodiments described herein with respect to computer system 500 are implemented with any appropriate logic, wherein the logic, as referred to herein, includes any suitable hardware (e.g., a processor, an embedded controller, or an application specific integrated circuit, among others), software (e.g., an application, among others), firmware, or any suitable combination of hardware, software, and firmware, in various embodiments.

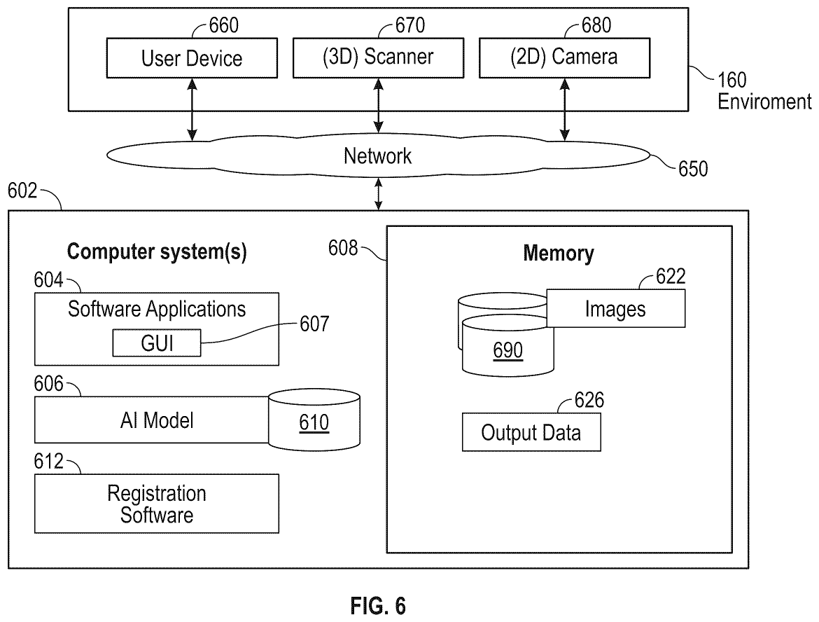

FIG. 6 is a block diagram of a computer system 602 for removing reflection artifacts from point clouds using artificial intelligence according to one or more embodiments. Elements of computer system 500 are used in and/or integrated in computer system 602 and user device 660. The computer system 602 and user device 660 includes any of the hardware and software described in computer system 500. An environment 160 includes a scanner 670 such as the laser scanner 20 discussed in FIGS. 1-4 and/or another suitable three-dimensional coordinate scanning device. The environment 160 includes a camera 680, for example, having features of the cameras 66, 112 of laser scanner 20 depicted in FIGS. 1-4 and/or another suitable camera. The scanner 670 is configured to measure three-dimensional coordinates of points in the environment or on an object. The scanner 670 is a time-of-flight scanner, a triangulation scanner, an area scanner, a structured light scanner, or a laser tracker for example.

Data 690 in memory 608 includes 3D point clouds of the environment 160 (also referred to as 3D point cloud data), point clouds, information about the position from where the points were captured, 3D images, scan data, scans, and the like. The 3D point cloud includes 3D point cloud data points. Data 690 in memory 608 includes 2D images 622 of the environment 160. In an embodiment, the 2D images 622 includes panorama images acquired while performing photogrammetry at a scene in the environment 160. Software application 604 is used with, or integrated in by other software applications, such as artificial intelligence (AI) model 606, registration software 612, photogrammetry software, and the like, for processing 3D point cloud data and 2D images 622 as readily understood by one of ordinary skill in the art. Software application 604 also includes graphical user interface (GUI) 607.

In one or more embodiments, software application 604 is employed by a user for processing and manipulating 2D images 622 and 3D point cloud data using a user interface such as, for example, a keyboard, mouse, touch screen, stylus, etc. Software application 604 includes and/or work with a graphical user interface (GUI), and features of the software application 604 receives the output from the AI model 606 (e.g., a machine learning model) to identify and remove reflection artifacts from 3D point cloud data as discussed herein. As understood by one of ordinary skill in the art, software application 604 includes functionality and/or is integrated with other software for processing any 2D image 622 and 3D image including a 3D point cloud. In one or more embodiments, the software application 604 includes features of, be representative of, and/or be implemented in FARO ZONE 2D, FARO ZONE 3D, FARO PHOTOCORE, and/or FARO SCENE software, all of which are provided by FARO Technologies, Inc.

Photogrammetry is a technique for modeling objects using images, such as photographic images acquired by a digital camera for example. Photogrammetry makes 3D models from 2D images or photographs. When two or more images are acquired at different positions that have an overlapping field of view, common points or features are identified on each image. By projecting a ray from the camera location to the feature/point on the object, the 3D coordinate of the feature/point is determined using trigonometry or triangulation. In some examples, photogrammetry is based on markers/targets (e.g., lights or reflective stickers) or based on natural features. To perform photogrammetry, for example, images are captured, such as with a camera (e.g., the camera 680) having a sensor, such as a photosensitive array for example. By acquiring multiple images of an object, or a portion of the object, from different positions or orientations, 3D coordinates of points on the object are determined based on common features or points and information on the position and orientation of the camera when each image was acquired. In order to obtain the desired information for determining 3D coordinates, the features are identified in two or more images. Since the images are acquired from different positions or orientations, the common features are located in overlapping areas of the field of view of the images. It should be appreciated that photogrammetry techniques are described in commonly-owned U.S. Pat. No. 10,597,753, the contents of which is incorporated by reference herein. With photogrammetry, two or more images are captured and used to determine 3D coordinates of features.

The various components, modules, engines, and the like, described regarding the computer system 602, the user device 660, the scanner 670, and the camera 680 are implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein is a combination of hardware and programming. The programming is processor executable instructions stored on a tangible memory, and the hardware includes the computer system 602 for executing those instructions. Thus, a system memory (e.g., the memory 608) stores program instructions that when executed by the computer system 602 implement the engines described herein. Other engines are also utilized to include other features and functionality described in other examples herein.

A network adapter (not shown) provides for the computer system 602 to transmit data to and/or receive data from other sources, such as other processing systems, data repositories, and the like. As an example, the computer system 602 transmits data to and/or receive data from the camera 680, the scanner 670, and/or the user device 660 directly and/or via a network 670.

The network 670 represents any one or a combination of different types of suitable communications networks such as, for example, cable networks, public networks (e.g., the Internet), private networks, wireless networks, cellular networks, or any other suitable private and/or public networks. Further, the network 670 has any suitable communication range associated therewith and includes, for example, global networks (e.g., the Internet), metropolitan area networks (MANs), wide area networks (WANs), local area networks (LANs), or personal area networks (PANs). In addition, the network 650 includes any type of medium over which network traffic is carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

The camera 680 is a 2D camera or a 3D camera (RGBD or time-of-flight, for example). The camera 680 captures an image (or multiple images), such as of an environment 160. The camera 680 transmits the images to the computer system 602. In one or more embodiments, the camera 680 encrypts the image before transmitting it to the computer system 602. Although not shown, the camera 680 includes components such as a processing device, a memory, a network adapter, and the like, which is functionally similar to those included in the computer systems 500, 602 as described herein.

In some examples, the camera 680 is mounted to a mobile base, which is moved about the environment 160. In some examples, the camera 680 is disposed in or mounted to an unmanned aerial vehicle. In various examples, the camera 680 is mounted on a manned aerial vehicle and/or unmanned aerial vehicle, generally referred to as a drone. In some examples, the camera 680 is mounted to a fixture, which is user-configurable to rotate about a roll axis, a pan axis, and a tilt axis. In such examples, the camera 680 is mounted to the fixture to rotate about the roll axis, the pan axis, and the tilt axis. Other configurations of mounting options for the camera 680 also are possible.

A coordinate measurement device, such as scanner 670 for example, is any suitable device for measuring 3D coordinates or points in an environment, such as the environment 160, to generate data about the environment. The scanner 670 is implemented as a TOF laser scanner 20. A collection of 3D coordinate points is sometimes referred to as a point cloud. According to one or more embodiments described herein, the scanner 670 is a three-dimensional (3D) laser scanner time-of-flight (TOF) coordinate measurement device. It should be appreciated that while embodiments herein refer to a laser scanner, this is for exemplary purposes and the claims should not be so limited. In other embodiments, other types of coordinate measurement devices or combinations of coordinate measurement devices are used, such as but not limited to triangulation scanners, structured light scanners, laser line probes, photogrammetry devices, and the like. A 3D TOF laser scanner steers a beam of light to a non-cooperative target, such as a diffusely scattering surface of an object for example. A distance meter in the scanner 670 measures a distance to the object, and angular encoders measure the angles of rotation of two axles in the device. The measured distance and two angles enable a processor in the scanner 670 to determine the 3D coordinates of the target.

A TOF laser scanner, such as the scanner 670, is a scanner in which the distance to a target point is determined based on the speed of light in air between the scanner and a target point. Laser scanners are typically used for scanning closed or open spaces such as interior areas of buildings, industrial installations, and tunnels. They are used, for example, in industrial applications and accident reconstruction applications. A laser scanner, such as the scanner 670, optically scans and measures objects in a volume around the scanner 670 through the acquisition of data points representing object surfaces within the volume. Such data points are obtained by transmitting a beam of light onto the objects and collecting the reflected or scattered light to determine the distance, two-angles (i.e., an azimuth and a zenith angle), and optionally a gray-scale value. This raw scan data is collected, optionally processed, stored, transmitted to the computer system 602 and stored in the database 690 about the environment 160. Either on the scanner or on the computer system, the raw scan data is converted into a point cloud. The information about the position of the scanner relative to the points is usually lost during this conversion. However, it is desirable to preserve this information, which in various embodiments is done by adding the position from where the data points have been captured as meta-information that is stored, for example, in the data 690 of the memory 608.

In some examples, the scanner 670 is mounted to a mobile base, which is moved about the environment 160. In some examples, the scanner 670 is disposed in or mounted to an unmanned aerial vehicle. In various examples, the scanner 670 is mounted on a manned aerial vehicle and/or unmanned aerial vehicle, generally referred to as a drone. In some examples, the scanner 670 is mounted to a fixture, which is user-configurable to rotate about a roll axis, a pan axis, and a tilt axis. In such examples, the scanner 670 is mounted to the fixture to rotate about the roll axis, the pan axis, and the tilt axis. Other configurations of mounting options for the scanner 670 also are possible.

According to one or more embodiments described herein, the camera 680 captures 2D image(s) of the environment 160 and the scanner 670 captures 3D information of the environment 160. In some examples, the camera 680 and the scanner 670 are separate devices. However, in some embodiments, the camera 680 and the scanner 670 are integrated into a single device. For example, the camera 680 includes depth acquisition functionality and/or is used in combination with a 3D acquisition depth camera, such as a time-of-flight (TOF) camera, a stereo camera, a triangulation scanner, LIDAR, and the like. In some examples, 3D information is measured/acquired/captured using a projected light pattern and a second camera (or the camera 680) using triangulation techniques for performing depth determinations. In some examples, a TOF approach is used to enable intensity information (2D) and depth information (3D) to be acquired/captured. The camera 680 is a stereo-camera to facilitate 3D acquisition. In some examples, a 2D image and 3D information (i.e., a 3D data set) is captured/acquired at the same time; however, the 2D image and the 3D information is obtained at different times.

The user device 660 (e.g., a smartphone, a laptop or desktop computer, a tablet computer, a wearable computing device, a smart display, and the like) is also located within or proximate to the environment 160. The user device 660 displays an image of the environment 160, such as on a display of the user device 660 (e.g., the display 519 of the computer system 500 of FIG. 5) along with a digital visual element. In some examples, the user device 660 includes components such as a processor, a memory, an input device (e.g., a touchscreen, a mouse, a microphone, etc.), an output device (e.g., a display, a speaker, etc.), and the like.

Registration is performed by registration software 612 and/or any registration software known by one or ordinary skill in the art. Registration is a component in the laser scanning and post processing workflow. Registration, point cloud registration, or scan matching are the processes of finding a spatial transformation (e.g., scaling, rotation, and translation) that aligns two or more point clouds. Moreover, registration is the process of aligning two or more 3D point clouds of the same scene into a common coordinate system. The purpose of finding such a transformation includes merging multiple data sets into a globally consistent model or coordinate frame, and mapping a new measurement to a known data set to identify features or to estimate the pose of the measuring device. Scanning an environment consisting of reflective surfaces (such as, e.g., windows, mirrors, etc.) results in point clouds containing many virtual points generated by the reflections off such surfaces. These virtual points correspond to real objects in the recorded scene but at a wrong (i.e., mirrored) position. In order to have good registration results, the user needs to remove these virtual points first. In typical scenarios, there are more than 30, 50, or 100 scans per project, with each scan containing many thousands or millions of points, and so manually cleaning the artifacts in all these scans requires enormous time and effort as noted herein. Accordingly, automatic (or partially automated) cleanup of these 3D points is provided using one or more of the functionalities now introduced herein.

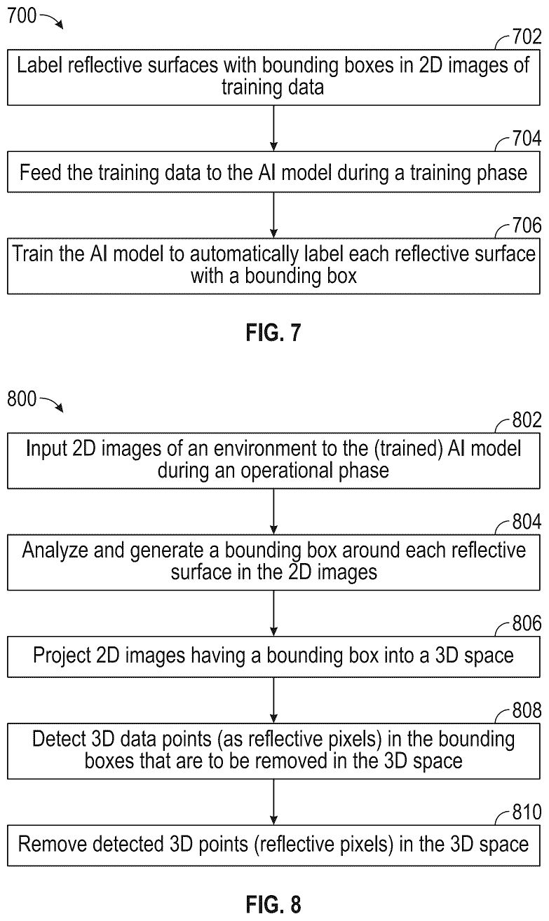

FIG. 7 depicts a flowchart of a computer-implemented method 700 for training an artificial intelligence (AI) model for detecting and generating a bounding box around reflective surfaces according to one or more embodiments. The AI model 606 is used in computer system 602 to detect/identify reflective surfaces in 2D images and then generate a bounding box around each detected reflective surface. The bounding box has bounding coordinates that encompass the reflective surface.

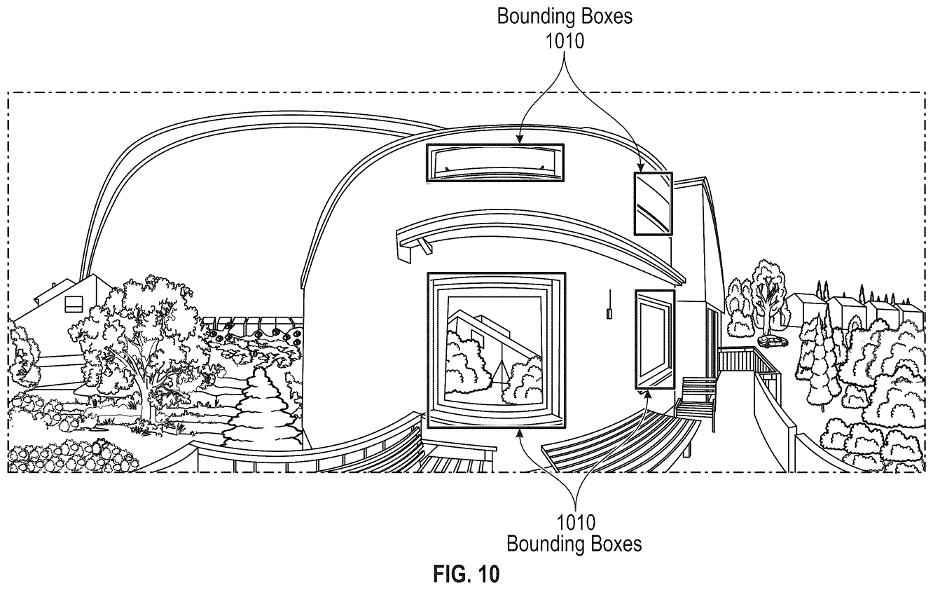

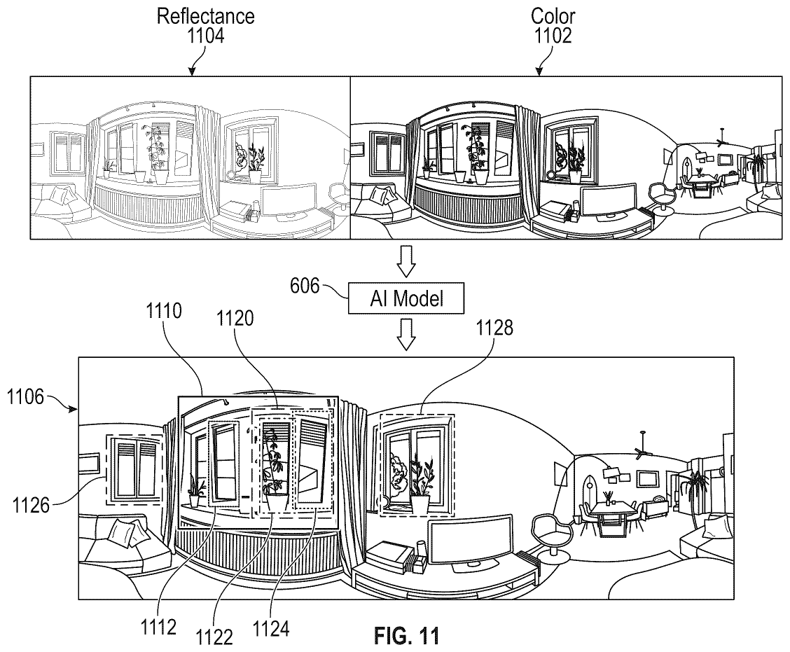

At block 702 of the computer-implemented method 700, 2D images are extracted and labelled to be utilized as labeled training data 610. In some embodiments, the 2D images include reflective surfaces. The reflective surfaces are labeled with bounding boxes in the 2D images, in various instances. At block 704 of the computer-implemented method 700, the AI model 606 is input/fed to the labeled training data 610 during the training phase. The labeled training data 610 includes RGB 2D color images with bounding boxes around each reflective surface, such as windows, mirrors, etc., that are to be identified. The labeled 2D color images along with intensity information from the scanner are used to train the AI model 606 at block 706. In particular, grayscale intensity information (i.e., reflectance) is fed with the labeled 2D color images to train the AI model to learn to detect and draw bounding boxes around reflective surfaces. The grayscale intensity information serves as an extra input signal which helps the AI model generalize better, because the grayscale intensity information provides beneficial structural information. In one or more embodiments, both the labeled RGB color image and its corresponding (identical) grayscale/reflectance image are fed to the AI model 606 for training. For example, FIG. 9 illustrates an example RGB color image having reflective surfaces each labeled with a bounding box according to one or more embodiments. As an example of training data 610, FIG. 9 illustrates annotated windows with bounding boxes 901 encompassing the reflective surfaces. FIG. 10 illustrates an example RGB color image having each reflective surface labeled with a bounding box of the bounding boxes 1010 according to one or more embodiments. FIG. 10 illustrates annotated windows with bounding boxes 1010 as training data. The AI model 606 was trained with RGB 2D panoramas but it should be appreciated that in other embodiments, other color 2D images are likewise utilized for training.

At block 706 of the computer-implemented method 700, the AI model 606 analyzes the labeled images in the training data 610 to learn the reflective surfaces that are to be classified or labeled, and then correspondingly draws bounding boxes around the detected reflective surfaces. Moreover, after training the AI model 606, the software application 604 feeds an unlabeled RGB color image and the intensity information for that RGB color image to the AI model 606, which in turn, is trained to draw bounding boxes around the reflective surfaces (if present) in the RGB color image. As a result, the AI model 606 has been successfully trained to detect and label the reflective surfaces depicted in FIGS. 9 and 10.

In one or more embodiments, the AI model 606 is a machine learning engine, such as an artificial neural network inference engine or a deep learning engine in various non-limiting embodiments. The AI model 606 is trained to produce characteristics associated with human intelligence, such as language comprehension, problem solving, pattern recognition, learning, and reasoning from incomplete or uncertain information. As a result of the training phase, the AI model 606 is now trained to detect reflective surfaces in a 2D image and classify/label the detected reflective surfaces with a bounding box where the 2D images have been captured using the camera 680, scanner 670, and/or any other suitable device.

In one or more embodiments, the AI model 606 includes various engines/classifiers and/or is implemented on a neural network. The features of the engines/classifiers are implemented by configuring and arranging the computer system 602 to execute machine learning algorithms. In general, machine learning algorithms, in effect, extract features from received data (e.g., inputs of 2D images) in order to “classify” the received data. Examples of suitable classifiers include but are not limited to neural networks, support vector machines (SVMs), logistic regression, decision trees, hidden Markov Models (HMMs), and the like. The end result of the classifier's operations, i.e., the “classification,” is to predict a class for the data. The machine learning algorithms apply machine learning techniques to the received data in order to create/train/update a unique “model” over time. The learning and training performed by the engines/classifiers are supervised, unsupervised, or a hybrid thereof that includes aspects of supervised and unsupervised learning. Supervised learning is when training data is already available and classified/labeled. Unsupervised learning is when training data is not classified/labeled so must be developed through iterations of the classifier. Unsupervised learning utilizes additional learning/training methods including, for example, clustering, anomaly detection, neural networks, deep learning, and the like.

In one or more embodiments, the engines/classifiers are implemented as neural networks (or artificial neural networks), which use a connection (synapse) between a pre-neuron and a post-neuron, thus representing the connection weight. Neuromorphic systems are interconnected elements that act as simulated “neurons” and exchange “messages” between each other. Similar to the so-called “plasticity” of synaptic neurotransmitter connections that carry messages between biological neurons, the connections in neuromorphic systems such as neural networks carry electronic messages between simulated neurons, which are provided with numeric weights that correspond to the strength or weakness of a given connection. The weights are adjusted and tuned based on experience, making neuromorphic systems adaptive to inputs and capable of learning. After being weighted and transformed by a function (i.e., transfer function) determined by the network's designer, the activations of these input neurons are then passed to other downstream neurons, which are often referred to as “hidden” neurons. This process is repeated until an output neuron is activated. Thus, the activated output neuron determines (or “learns”) and provides an output or inference regarding the input.

Neural networks are usually created with base networks and based on requirements. Example base networks utilized include RESNET50, RESNET 10, and XCEPTION. It should be appreciated that other base network could be utilized for images. After the creation of the neural network, the dataset (training and testing) is fed to the model with the specific loss function and the training is started. Training consists of different hyper-parameters that need to be set in order to achieve better accuracy. The dataset that is fed into the deep learning model is processed. For illustration and not limitation, the training datasets 610 includes 2D panoramas (i.e., 2D images) with labeled windows, mirrors, glass or glass surfaces, glass doors, windows of vehicles, and the like. Supervised learning is utilized in which the 2D images were manually labeled and fed to the neural network.

The raw dataset is collected and sorted manually. The sorted dataset is labeled (e.g., using the AMAZON WEB SERVICES (AWS) labeling tool such as AMAZON SAGEMAKER GROUND TRUTH). The labeling tool creates labeled images. The labeled images and unsorted images are sorted in order to achieve data balancing and divided into training, testing, and validation datasets. Training and validation are used for training and evaluation, while testing is used after training to test the machine learning model on an unseen dataset. The training dataset is processed through different data augmentation techniques. Training takes the labeled datasets, base networks, loss functions, and hyper-parameters. Once these are all created and compiled, the training of the neural network occurs to eventually result in the trained machine learning model. Once the model is trained, the model (including the adjusted weights) is saved to a file for deployment and/or further testing on the test dataset.

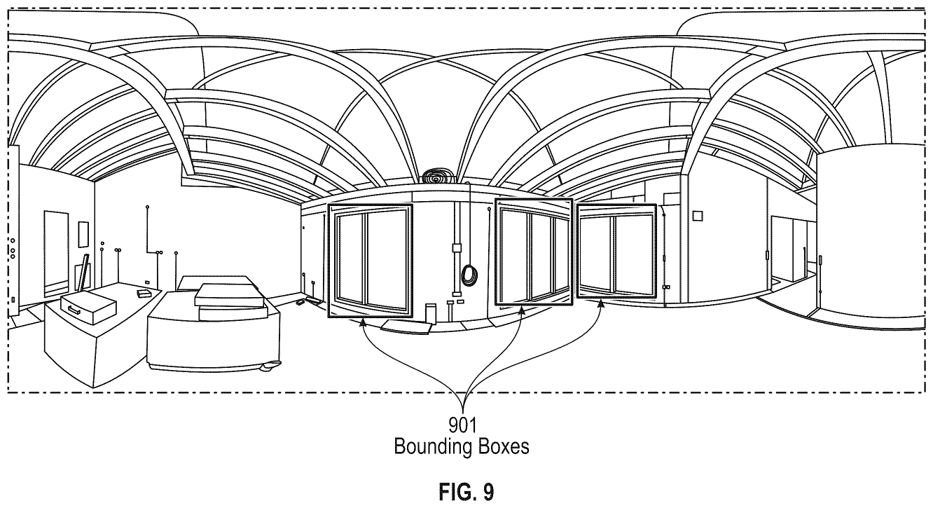

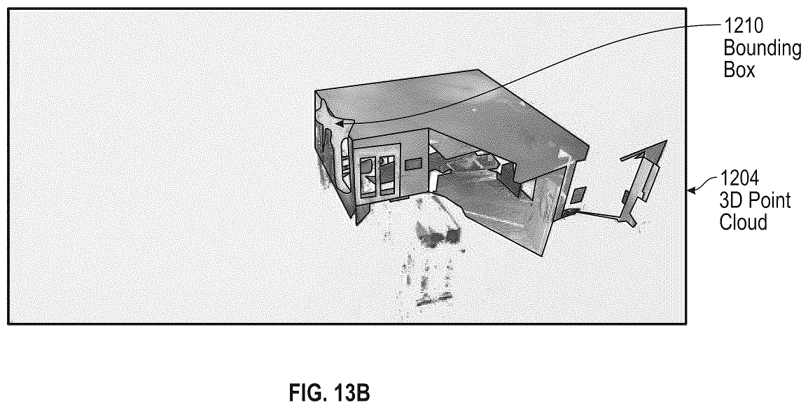

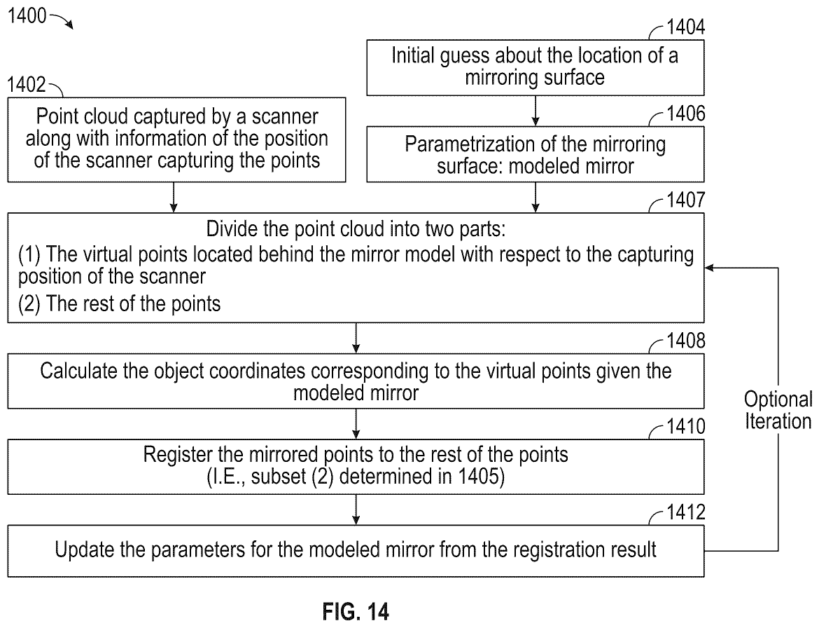

FIG. 8 depicts a flowchart of a computer-implemented method 800 for automatic coarse identification of mirroring surfaces in 3D images according to one or more embodiments. During an operational phase (i.e., normal operation of the AI model 606), the computer system 602 uses 2D images captured by the scanner to generate a bounding box around each reflective surface. The pixels within the bounding box are then projected into the 3D point cloud, where the points are clustered into reflected and non-reflected points. This classification is accompanied by a coarse model for the mirror location. It should be noted that this model is used to delete the points identified as reflections from the 3D point cloud (FIG. 13B). For example, the removed data points 1206 in FIG. 13A are not present in FIG. 13B. However, according to one or more embodiments this model is used as starting point to determine very precisely the mirror position, orientation, and its extent, such that the reflected points are repositioned in the correct place within the 3D point cloud.

At block 802 of the computer-implemented method 800, the software application 604 is configured to input color 2D images and their associated intensity information of the environment 160 to the (trained) AI model 606 during an operational phase, which generates output data 626. A grayscale image or reflectance image comprises intensity information. Each pixel of the color 2D images includes intensity data and further includes depth data. Depth data is also sometimes referred to herein as range values or distance values.

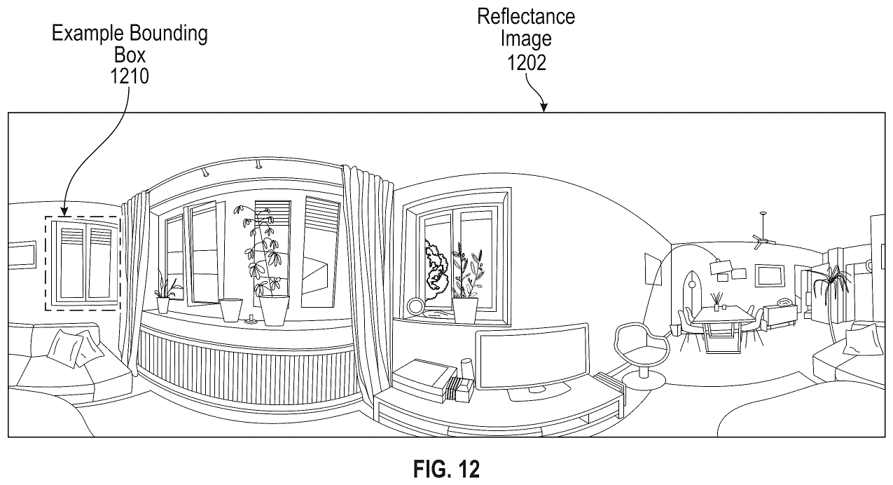

At block 804, the software application 604 is configured to receive the output data 626 from the AI model 606, in which the output data 626 includes the 2D images annotated with bounding boxes respectively encompassing each of the reflective surfaces. The AI model 606 detects each reflective surface in the 2D images and generates a bounding box around each of the reflective surfaces in a 2D image. FIG. 11 is an example illustrating an RGB 2D color image 1102 and intensity information 1104 input to the AI model 606, which generates bounding boxes encompassing the reflective surfaces in the RGB color image 1106 as the output data. In some embodiments, the intensity information 1104 is a grayscale or reflectance image of the RGB color image. As seen in RGB color image 1106, a large bounding box 1110 encompasses a large reflective surface which is a large window. There are smaller size bounding boxes surrounding smaller sections of the large window in various instances. For example, bounding box 1112 encompasses a smaller section of the large window. Within the large bounding box, there is a medium bounding box 1120 that encompasses a medium size section of the large window. Within the medium bounding box 1120, there are two smaller bounding boxes 1122, 1124 each encompassing a smaller section of the portion of the large window within the medium bounding box 1120. Other bounding boxes 1126, 1128 are also present. Each of the bounding boxes has its own bounding coordinates that form the box. Each bounding box is further processed to identify reflected points according to the methods described herein.

At block 806, the software application 604 is configured to project each of the 2D images having a bounding box of a reflective surface into a 3D space, such as a 3D point cloud of the environment 160. The bounding box and/or the location of the bounding box in 2D space is translated into the corresponding location in the 3D point cloud by the inverse projection used to generate the 2D images. For equirectangular projection, every row/column of the image is a coordinate in the spherical coordinate system with (phi, theta) values. The software application 604 uses these spherical coordinate values and the depth information to convert from the spherical coordinate system to the Cartesian coordinate system (x, y, and z coordinates) and then locate the point in the 3D space. It is noted that the bounding boxes restrict the location of the mirror surfaces in the 3D point cloud. The bounding boxes are utilized to provide an estimate or initial position of the mirror surface for further processing, as discussed herein, in accordance with one or more embodiments.

At block 808, the software application 604 is configured to identify 3D data points as reflected points in the bounding boxes. This allows to distinguish between reflected and non-reflected points within the bounding boxes. This distinction is used at block 810 to get a rough estimate of the position and extent of the reflective surface.

Once the bounding boxes are placed or drawn in the 2D image, the software application 604 utilizes multiple approaches to identify 3D data points as reflected points. A few example approaches utilized to detect 3D data points as reflected points include (1) intensity data clustering and thresholding, (2) depth data clustering and thresholding, (3) using plane detection, and/or any suitable approach. In one or more embodiments, a combination of such approaches is utilized.

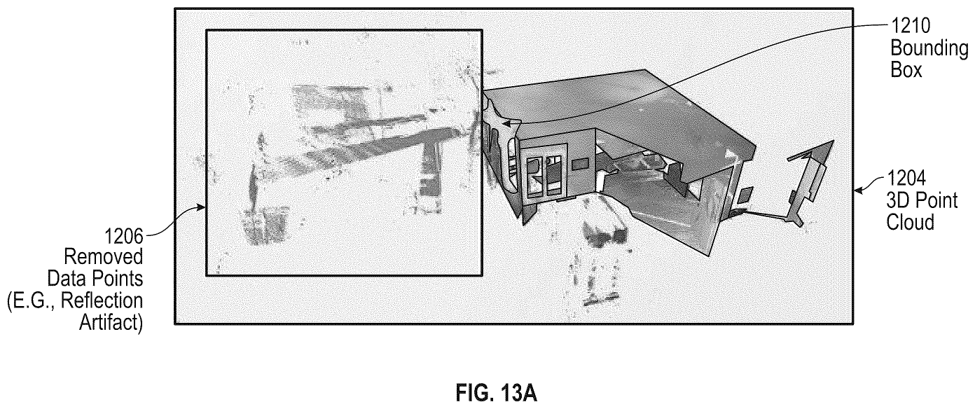

One approach for detecting 3D data points as reflective pixels in the bounding boxes is intensity data clustering and thresholding. The intensity of the measured laser signal is used for this determination. The software application 604 is configured to pick the 3D data points inside the bounding box and apply a clustering technique to cluster the 3D data points based on their intensity values. There is a cluster of 3D data points that corresponds to the pixels on the reflective surface as well as some clusters representing other 3D data points that lie within the bounding box (e.g., the window frame or some other object encapsulated by the bounding box). The intensity of a diffusely scattered laser beam decreases considerably with the distance. As consequence, the intensity signal from a transparent surface (e.g. a window) is usually lower compared to its frame, because the reflected signal originates from a greater distance. Thus, the software application 604 is configured to select the cluster of 3D data points with the lowest mean intensity value and identify these as reflected points. For example, the reflectance in the selected cluster is determined to be lower than a predefined reflectance threshold. As seen in FIG. 12, the reflectance image 1202 illustrates an example bounding box encompassing a window. As shown in FIG. 12, the mean intensity on the reflective surfaces, such as inside the bounding box 1210 (and other windows), is lower (i.e., darker) than the mean intensity of directly adjacent areas. Accordingly, the 3D data points in the cluster having an intensity value below the predefined reflectance threshold are identified as reflected points. Further, FIG. 13A illustrates a 3D point cloud 1204 of the same environment of FIG. 12. In FIG. 13A, it is seen that, based on the thresholding concept, the software application 604 is configured to identify the 3D data points on the reflective surface accurately without classifying the other points in the bounding box as reflective surface points. When using intensity data clustering, the mirroring surface is modeled by a plane that separates the 3D points identified as reflections and the rest of the points for example. The model is further refined by considering the extension of the mirror surface, for example via the bounding box.

Another example approach for detecting 3D data points as reflective pixels in the bounding boxes is depth data clustering and thresholding. This approach is analogous to intensity data clustering and thresholding except the clustering and thresholding are for the depth data. For example, the software application 604 is configured to find and cluster points that have the highest mean depth value. The depth value is the distance of a 3D data point to the capturing device (e.g., the scanner 670). Accordingly, for any cluster of 3D data points that have a value or mean value greater than a depth threshold, the 3D data points in these clusters are identified as reflection artifacts. An example of the reflection artifacts is provided in FIG. 13A and are oftentimes referred to as removed data points 1206. The depth threshold is determined from a histogram that shows the distribution of all depth values within the bounding box. The depth corresponding to the first peak in this histogram is used as depth threshold. This is motivated by the fact that the first peak in the histogram is usually caused by the frame of the mirroring surface (e.g. window frame in bounding box 1210 of FIG. 12). When using depth data clustering and thresholding, the mirroring surface is modeled by a plane that is located at a distance equal to the depth threshold from the scanner. The normal of the plane is given by the vector pointing from the scanner location to the center of the bounding box.

Another example approach for detecting 3D data points as reflective pixels in the bounding boxes is based on plane detection. After the AI model 606 generates the bounding box around the reflective surface, the software application 604 is configured to fit a plane through the 3D points represented by the border of the bounding box (which corresponds typically to the frame of a reflective surface, see bounding box 1210 in FIG. 12). The plane together with the view frustum defined by the bounding box provides a rough estimation of the location and extension of the mirroring surface (810 in FIG. 8).

At least one of the above approaches is used to obtain an initial parametrization for the mirror surface. Separating the points within the bounding box into reflected points and non-reflected points allows the identification of points adjacent to the mirroring surface, which are typically points on window frames, surrounds, or walls. These non-reflective points at the margin of the bounding box can, for example, be used to fit a plane through them. Such a plane, together with the assumed reflective points, are used in one or more embodiments as initial estimation to precisely measure the position of the mirror in the point cloud captured by a scanner.

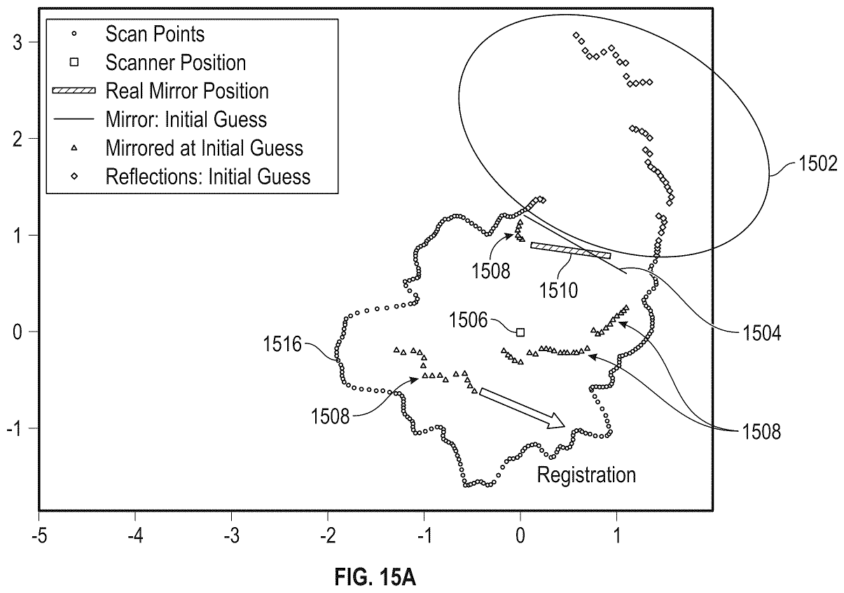

FIG. 14 depicts a flowchart of a computer-implemented method 1400 for measuring/determining the exact position of a mirror surface within a 3D point cloud from an initial estimation, and additionally, integrating mirrored points back into the 3D point cloud according to one or more embodiments. As noted herein, the data 690 includes 3D point clouds, the information from where the points were captured, and optionally 2D images of the (same) environment 160 (i.e., the same scene). The software application 604 implements one or more algorithms according to one or more embodiments.

At block 1402, the software application 604 is configured to receive/retrieve input of a 3D point cloud of the environment 160 (e.g., a scene) captured by, for example, the scanner 670 along with information of the position of the scanner 670 capturing the 3D points of the scene. The point cloud data includes 3D point coordinates along with the relative coordinates (i.e., the position) of the scanner 670 from where the points were captured. The point cloud data could, for example, could be obtained from one or more scans of a TOF laser scanner. Optionally, there is additional information associated with the individual 3D points, such as, for example, a color value from a color camera or a grey scale value from the laser intensity. However, this additional data is not generally required for the main algorithm described herein, but it could be used to obtain an initial estimation of the location of a mirroring surface. If the point cloud data is obtained from more than one scan, the individual scans are registered against each other first, and/or the algorithm is applied to each scan individually.

At block 1404, the software application 604 is configured to obtain an initial estimate of the location/position of a mirror surface in the 3D point cloud. The terms “mirror surface” and “mirroring surface” are used interchangeably with a reflective surface. In one or more embodiments, the initial estimate of the location and geometry of a mirroring surface is obtained from manual user input. The user can, for example, select a mirroring surface by identifying a plane into the 3D point cloud, by selecting points via a bounding box in a 2D representation of the scanned points as viewed from the scanner location, by selecting a line in a top view projection of the point cloud, and/or by any other form of suitable user selection. In one or more embodiments, a pattern recognition algorithm is then utilized to select the mirror surface position as the initial estimate. In one or more embodiments, the AI model 606 is utilized to select the mirror surface position as described by the computer implemented method 800. Other techniques are likewise useful for the initial estimate. It should be appreciated that the initial estimate is not required to be precise. From the scanner's point of view, the initial estimate should preferably (but not necessarily) include the entire mirror surface. In other words, the entire mirror should be included in the view frustum defined by the initial estimate. Where appropriate, one or more embodiments reduce the size of the mirror as discussed herein.

At block 1406, the software application 604 is configured to determine the parametrization of the mirror surface (e.g., mirror model). Possible mirror models include, for example, a plane having infinite dimensions that fits the position/orientation of the mirror, a planar polygon that fits the position/orientation and the dimensions (width/height) of the mirror, a polygon mesh, a parametrized geometric surface, and/or any other parametrization that could be used to model a mirror surface. The selected mirror model determines the outcome. Further, any suitable technique for the parameterization of the mirror surface is utilized as understood by one of ordinary skill in the art.

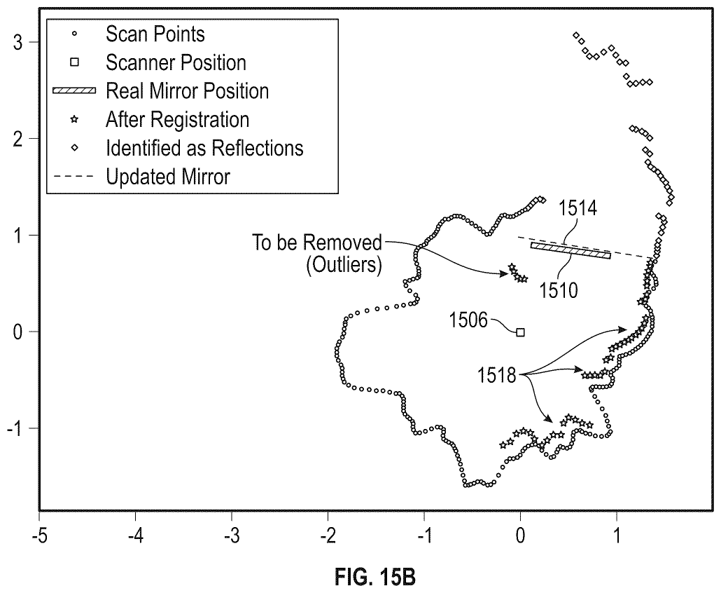

FIG. 15A depicts a 2D point cloud of the environment 160 (i.e., the scene). In FIG. 15A, the mirror surface is illustrated together with an initial estimate for the 2D point cloud. In this 2D example, mirror position 1510 is the actual mirror position, and mirror position 1504 is the initial estimate of the mirror position. It should be appreciated that the mirror position 1510 is not known in advance. As viewed from the scanner position 1506, the mirror surface is included completely in the view frustum defined by the initial estimate. The front and back of the mirror surface are defined with respect to the side facing the scanner position 1506. For example, the front of the mirror surface is the side facing the scanner position 1506 of the scanner 670, while the back of the mirror surface is the side away from the scanner position 1506. In some cases, the mirror surface is reflecting from both sides, such as a window or glass, but for explanation purposes, the front side is toward the scanner position 1506 in this example.

Referring to FIG. 14, at block 1407, the software application 604 is configured to divide the 2D point cloud into two parts, which includes a first part and a second part. For example, the point cloud data is given by the set of points {Pi} where Pi represents a vector of Cartesian coordinates. Although a 2D example is provided for illustration purposes, this process is applied by analogy to 3D coordinates as well as 2D coordinates. The position of the scanner from where Pi was captured is denoted by Oi. The point cloud data {Pi} is divided into two parts: (i) the (assumed) virtual points located behind the mirror model with respect to the capturing position, and (ii) the rest of the points. The point Pi belongs to part (i) if the line defined by [Pi Oi] crosses the surface of the mirror model. Otherwise, the point Pi belongs to part (ii). The virtual points are denoted by {Vi} and the rest of the points are denoted by {Pi}\{Vi}. In FIG. 15A, the point cloud {Pi} as measured from the scanner position 1506, is illustrated by the points making up line 1516 and the points enclosed in circle 1502. The virtual points {Vi} with respect to the mirror model at mirror position 1504 are marked as the points within the circle 1502.

At block 1408, the software application 604 is configured to calculate the object coordinates corresponding to the virtual points given the modeled mirror. For example, the virtual points are mirrored about the initial mirror position 1504 of the mirror surface, resulting in mirrored points 1508 in FIG. 15A.

In performing the mirroring operation for the virtual points presumed to be in the circle 1502, the mirroring operation is defined by the mirror model position 1504 and the location from where the virtual points were recorded. For a planar mirror model at the mirror position 1504, this means that the points {Vi} are simply mirrored on the mirror plane defined by the model.

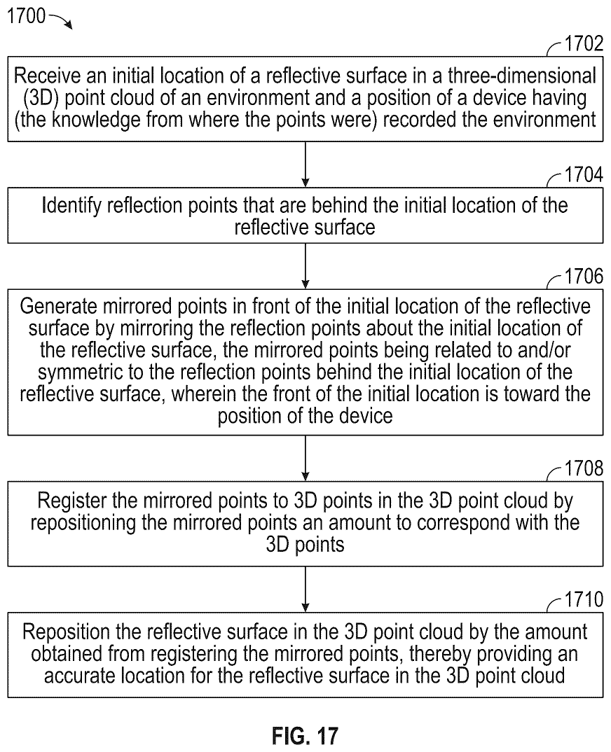

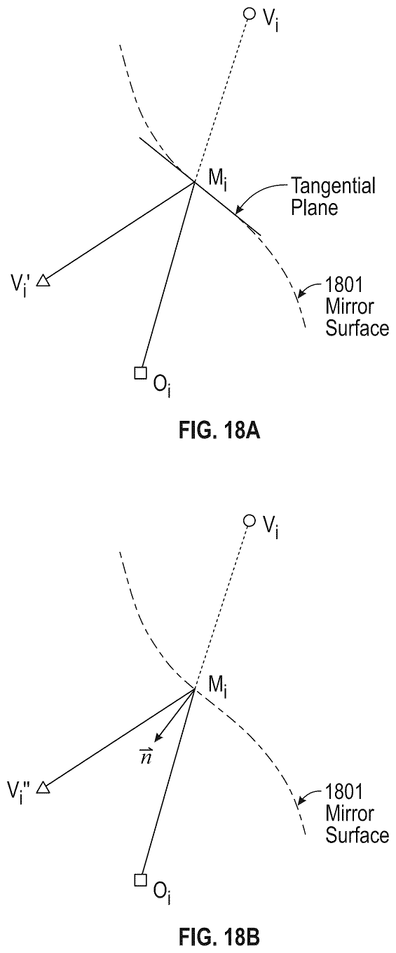

For general mirror models (i.e., in particular non-planar models), the object coordinates are obtained in a similar way by applying the laws of reflection. As shown in FIG. 18A, Vi′ is determined by mirroring Vi on the tangential plane 1803 in point Mi at the mirror surface 1801, where Mi is defined by the closest point to Oi on the line [Oi Vi] that crosses the mirror model.

Whether for a planar mirror model or a non-planar mirror model, the new points obtained after this mirroring operation are denoted by {Vi′}. In FIG. 15A, the point cloud corresponding to {Vi′} is denoted by the mirrored points 1508, resulting from the mirroring operation.

Referring to FIG. 14, at block 1410, the software application 604 is configured to register the mirrored points 1508 (or updated mirrored points which has been registered through a previous iteration) to the rest of the 3D points (e.g., non-mirrored 3D points in the point cloud), thereby determining adjustments needed for the mirrored points 1508. In this operation, the points {Vi′} are registered against the rest of the points determined in block 1407, i.e. {Pi}\{Vi}. Rigid as well as non-rigid registration algorithms are used for the registration. Rigid registration algorithms consider only the translation and rotation as degrees of freedom and thus preserve the distance between any two points. An example of a rigid registration algorithm is the Iterative Closest Point (ICP) method. Non-rigid registration algorithms include affine transformations (such as scaling and shear mapping) or nonlinear transformations. An example for a non-rigid registration algorithm is the Coherent Point Drift (CPD) algorithm. Rigid registration algorithms are suitable for addressing reflections from planar mirrors. Non-rigid registration algorithms are used to improve the convergence of this algorithm when addressing curved mirroring surfaces.

If the registration algorithm fails, then no mirroring surface is detected. In this case, the initial estimate (at block 1404) does not refer to a mirroring surface. Other causes for a failed registration are a poor initial estimate (at block 1404) or an inappropriate registration algorithm.

If the registration algorithm succeeds, this means that the original point cloud {Pi} contains duplicated parts that are mirrored. This is a good indication that a mirroring surface has been found.

At block 1412, the software application 604 is configured to update the parameters for the modeled mirror according to the registration result. The result of the successful registration in the previous operation is a coordinate transformation that maps {Vi′} to the new coordinates denoted by {Vi″} in FIG. 18B, such that {Vi″} is best aligned with {Pi}\{Vi}.

FIG. 15B illustrates the result of an example registration. In FIG. 15B, the registered points 1518 are much better aligned with the rest of the scan points than the mirrored points 1508 in FIG. 15A. Depending on the registration algorithm utilized, the alignment might not be within desired tolerances in some instances, as illustrated in FIG. 15B. Also, the alignment might not be within desired tolerances because the initial estimate (at block 1404) was requested to be larger than the mirroring surface, and thus {Vi} contains virtual points together with real points that were captured directly. These real points appear as outliers (as depicted in FIG. 15B) in the registration because these points do not have a duplicated counterpart in the original point cloud. To adjust the modeled mirror to the actual size of the mirroring surface, these outliers are to be removed from {Vi}, {Vi′}, and {Vi″}. One way to implement this is by using registration algorithms that include outlier removal methods as understood by one of ordinary skill in the art. A suitable outlier removal technique is the Guaranteed Outlier Removal (GORE). Another possibility is to evaluate, for each point of {Vi″}, the smallest distance to the points of {Pi}\{Vi} and consider every point with a distance greater than a predefined threshold as outlier. It should be appreciated that any other known outlier removal methods could be used as understood by one of ordinary skill in the art.

For generalized registration algorithms (rigid and non-rigid) and any kind of mirror models (at block 1406), the mirror model is updated by calculating a set of points that describe the mirror surface, wherein the mirror surface is denoted by {Mi}. The point Mi on the mirror surface that corresponds to the virtual point Vi and the real point Vi″ is uniquely defined by Mi∈[Oi Vi] and V̅_̅{̅ι̅}̅″̅M̅_̅{̅ι̅}̅=V̅_̅{̅ι̅}̅M̅_̅{̅ι̅}̅. In addition, the surface normal [symbol] on the point Mi is obtained from the normalized vector \vec{V_{ι}V_{ι}″}, as is illustrated in FIG. 18B.

For rigid registration algorithms and planar mirror models (i.e., a mirror plane in 3D or a line in 2D), a known technique is utilized to adjust the mirror model from the transformation in various embodiments. This is accomplished by solving an eigenvalue equation or by fitting a plane through the points {(Vi″+Vi)/2}. In other words, the mirror plane lays exactly between the objects and their mirrored counterparts.

The set of points that describe the mirror {Mi} are then used together with the surface normal [symbol] to fit the parameters for the mirror model. In FIG. 15B, the updated mirror model is indicated by the updated mirror position 1514.

As an option to improve the result, the software application 604 is configured to optionally iterate blocks 1407-1412 until the result converges. Convergence is reached, for example, when the registration error falls below a predefined threshold and/or when the change in the parameters that define the mirror model fall below a predefined threshold. Iterating the algorithm is advantageous, for example, in a case where the registration algorithm is not robust against outliers (which is the case for the basic Iterative Closest Point algorithm), for curved mirror models in combination with rigid registration algorithms, and/or when the user is interested in highly accurate results. FIG. 15C illustrates such an improved result after one additional iteration. Although not all outliers have been removed by the algorithm in FIG. 15C, the updated mirror position 1514 aligns almost perfectly with the real mirror position 1510. It should be appreciated that FIGS. 15A, 15B, and 15C illustrate different states of the computer-implemented method 1400.

There are many technical solutions and benefits according to one or more embodiments discussed herein. A method is provided to reject falsely positive detected mirror surfaces from other known methods (e.g., from an AI algorithm that detects mirrors): if the registration in block 1410 of FIG. 14 fails, it is determined that the initial selection likely contains no mirror. As further technical solutions and benefits, the algorithm outputs a point cloud {Mi} that describes the mirroring surface, namely the measured surface of the mirror. Technical solutions and benefits include a model of the mirroring surface. Also, technical solutions and benefits include the identification of reflected points in the point cloud, and thus the ability to precisely remove these reflections. Further, an increased point density is provided on certain objects that were scanned directly and through the mirroring surface. Additionally, one or more embodiments provide the ability to measure points on surfaces through a mirror that are not directly visible from the scanner location. Such points are identified using the mirror model obtained from the algorithm discussed herein. One or more embodiments are utilized to draw the set of points that describe the mirror surface into the original point cloud and/or visualize (insert) the identified mirror surface as a 3D object together with the point cloud.

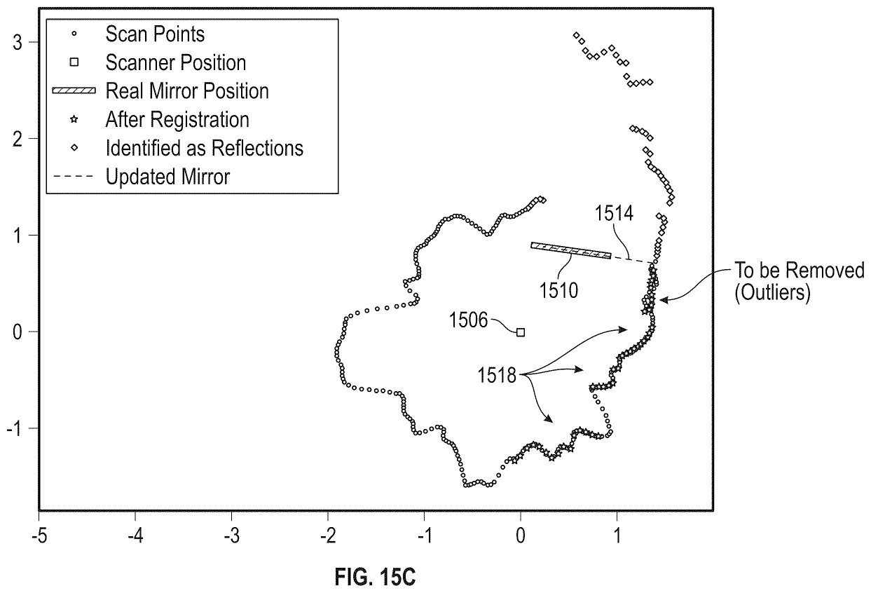

FIG. 16 depicts a front view of a 3D point cloud as measured from a TOF scanner augmented with points reflected at an assumed mirror plane. The captured room includes a large window front that acts as a mirroring surface. In this front view, the mirroring surface is an invisible vertical line in the center of FIG. 16 that divides the point cloud into two approximately symmetric parts (left and right). FIG. 16 demonstrates the computer-implemented method by modeling the mirroring window front as a simple plane. The initial position of this plane (not shown in FIG. 16) was chosen manually. In FIG. 16, the virtual points 1601 located behind the assumed mirror plane with respect to the location of the scanner 1605. The assumed mirror plane coincides with mirror surface position 1602. As discussed herein, the back projected virtual points 1604 are generated by mirroring the virtual points at the assumed mirror plane. The back projected virtual points 1604 are then successfully registered to the non-mirrored points of the scan 1603. The location of the back projected virtual points 1604 are relative to the assumed mirror location or plane. In contrast to FIG. 15B, the registered point cloud is aligned within a desired threshold after a single registration step. This allows embodiments to determine the actual mirror plane, namely, the bisector plane between the virtual points and the associated registered points. The determination of the actual mirror plane allows to precisely identify the virtual points in the scan, to remove these points or display them at the correct position.

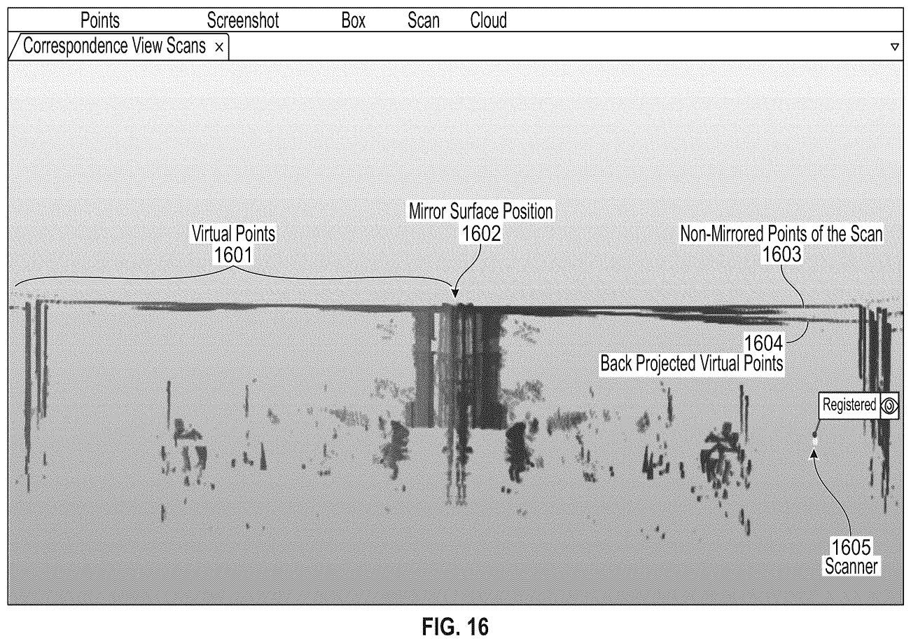

FIG. 17 summarizes the computer-implemented method described in 1400. The flowchart 1700 depicts a computer-implemented method 1700 for measuring/determining the position of a mirror surface in a 3D point cloud captured by a scanner. The computer system 602 is configured to perform the computer-implemented method 1700. Reference is made to any of the Figures discussed herein.

At block 1702, the software application 604 is configured to receive an initial location of a reflective surface (e.g., mirror surface position 1504 of the mirror surface) in a three-dimensional (3D) point cloud of an environment and receive a position (e.g., in Cartesian coordinates) of a device (e.g., scanner 670) for each recorded point of the point cloud. At block 1704, the software application 604 is configured to identify reflection points 1502 that are behind the initial location of the reflective surface (e.g., mirror surface position 1504 of the mirror surface) with respect to the position of the device. At block 1706, the software application 604 is configured to generate mirrored points 1508 by mirroring the reflection points 1502 about the initial location of the reflective surface, the mirrored points 1508 being related and/or symmetric to the reflection points 1502 on the opposite side of the initial location of the reflective surface. At block 1708, the software application 604 is configured to register the mirrored points to 3D points in the 3D point cloud by repositioning the mirrored points (e.g., updated mirrored points 1518 in FIGS. 15B and 15C) an amount to correspond with the 3D points. At block 1710, the software application 604 is configured to reposition the reflective surface (e.g., as updated mirror surface position 1514 of the mirror surface in FIGS. 15B and 15C) in the 3D point cloud such that the law of reflection is fulfilled for the repositioned mirrored points (e.g., repositioned mirror points 1518 in FIGS. 15B and 15C), the reflection points (e.g., 1502 in FIG. 15A), and the position of the device (e.g., 1506 in FIGS. 15A-C). This results in an accurate location for the reflective surface (e.g., mirror surface position 1514 of the mirror surface) in the 3D point cloud. It should be noted that the computer-implemented method 1700 are also likewise applicable to 2D point clouds as shown in FIG. 15A-C, as a 2D point cloud can be considered as a single plane of a 3D point cloud for such purposes.

In one or more embodiments, the repositioned mirrored points 1518 are utilized to make the 3D point cloud denser. Outliers of the mirrored points are determined by or after the registration, for example by evaluating the smallest distance to neighboring points, as depicted in FIG. 15B. The outliers are removed from the 3D point cloud, for example, as depicted in FIG. 15C. The reflective surface is positioned at a midpoint between the reflection points and the mirrored points that have been registered, as depicted in FIG. 18B. For example, FIGS. 15B and 15C depict the mirror surface position 1514 of the mirror surface halfway between the reflection points and the updated mirrored points 1518.

The results of method 1700 are improved by optionally iterating blocks 1704-1710 until the registration result in 1708 converges. The iteration over blocks 1704-1710 is accompanied by a variational approach, namely, before continuing the iteration in block 1704, the properties of the mirror (e.g. the position, orientation, extension, and curvature) are changed by an arbitrary small amount. If such a small change improves the registration result in 1708, the change is adopted, and when not improved the registration result is rejected. The variational approach is particularly suitable for fine-tuning, e.g. to determine the dimensions or curvature of the mirror surface very precisely.

It will be appreciated that aspects of the present disclosure are embodied as a system, method, or computer program product and takes the form of a hardware embodiment, a software embodiment (including firmware, resident software, micro-code, etc.), or a combination thereof. Furthermore, aspects of the present invention take the form of a computer program product embodied in one or more computer readable medium(s) having computer readable program code embodied thereon.

One or more computer readable medium(s) are utilized. The computer readable medium is a computer readable signal medium or a computer readable storage medium, in various embodiments. A computer readable storage medium, is by non-limiting example, one or more of an electronic, magnetic, optical, electromagnetic, infrared, or semiconductor system, apparatus, or device, or any suitable combination of the foregoing. More specific examples of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In one aspect, the computer readable storage medium is a tangible medium containing or storing a program for use by, or in connection with, an instruction execution system, apparatus, or device.

A computer readable signal medium includes a propagated data signal with computer readable program code embodied therein, for example, in baseband or as part of a carrier wave. Such a propagated signal takes any of a variety of forms, including, but not limited to, electro-magnetic, optical, or any suitable combination thereof. A computer readable signal medium is any computer readable medium that is not a computer readable storage medium and that communicates, propagates, or transports a program for use by or in connection with an instruction execution system, apparatus, or device.

In various embodiments, the computer readable medium contains program code embodied thereon, which is transmitted using any appropriate manner, including but not limited to wireless, wireline, optical fiber cable, radio frequency (RF), and the like, or any suitable combination of the foregoing. In addition, computer program code for carrying out operations for implementing aspects of the present invention is written in any combination of one or more programming languages, including an object-oriented programming language such as JAVA, SMALLTALK, C++ or the like and conventional procedural programming languages, such as the “C” programming language or similar programming languages. The program code executes entirely on the user's computer, partly on the user's computer, as a stand-alone software package, partly on the user's computer and partly on a remote computer or entirely on the remote computer or server.

It will be appreciated that aspects of the present disclosure are described herein with reference to flowchart illustrations and/or block diagrams of methods, apparatus (systems) and computer program products according to embodiments of the disclosure. It will be understood that each block or step of the flowchart illustrations and/or block diagrams, and combinations of blocks or steps in the flowchart illustrations and/or block diagrams, is implemented by computer program instructions. These computer program instructions are provided to a processor of a general purpose computer, special purpose computer, or other programmable data processing apparatus to produce an improved machine, such that the instructions, which execute via the processor of the computer or other programmable data processing apparatus, include non-generic functionality for implementing the functions/acts specified in the flowchart and/or block diagram block or blocks discussed herein.

In various instances, these computer program instructions are stored in a computer readable medium that directs a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions are also loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Terms such as processor, controller, computer, DSP, FPGA are understood in this document to mean a computing device that are located within an instrument, distributed in multiple elements throughout an instrument, or placed external to an instrument.

In addition to one or more of the features described herein, or as an alternative, further embodiments of the method include wherein the mirrored points are utilized to make the 3D point cloud denser.

In addition to one or more of the features described herein, or as an alternative, further embodiments of the methods include repeating one or more of registering, identifying and removing, calculating, and updating to improve accuracy.

In addition to one or more of the features described herein, or as an alternative, further embodiments of the methods include utilization of mirrored points having been registered to make point clouds denser.

In addition to one or more of the features described herein, or as an alternative, further embodiments of the method include utilization of the mirrored points having been registered to add points that are not directly visible from the position of the device.

In addition to one or more of the features described herein, or as an alternative, further embodiments of the methods include removing the virtual points from the point cloud.

In addition to one or more of the features described herein, or as an alternative, further embodiments of the methods include wherein a failed registration is taken as a criterion to reject false positively detected mirror surfaces from other mirror detection methods.

In addition to one or more of the features described herein, or as an alternative, further embodiments of the method include an artificial intelligence (AI) model that is trained to determine the initial location of the reflective surface.

While the invention has been described in detail in connection with only a limited number of embodiments, it should be readily understood that the disclosure is not limited to such disclosed embodiments. Rather, itis modified to incorporate any number of variations, alterations, substitutions or equivalent arrangements not heretofore described, but which are commensurate with the spirit and scope of the disclosure. Additionally, while various embodiments of the disclosure have been described, it is to be understood that aspects thereof are only some of the described embodiments. Accordingly, the disclosure is not to be seen as limited by the foregoing description but is only limited by the scope of the appended claims.

What is claimed is:

1. A computer-implemented method comprising:
receiving an initial location for a modeled reflective surface in a point cloud of an environment and information from which coordinates of points of the point cloud were captured by a device;
dividing the point cloud into two parts comprising virtual points that are behind the modeled reflective surface with respect to a position from where the points were recorded, and a remainder of points that are not behind the modeled reflective surface;
generating mirrored points by applying a law of reflection to the virtual points with respect to the modeled reflective surface and the position from where the points were recorded;
registering the mirrored points to the rest of the points in the point cloud;
identifying and removing the mirrored points that do not align with the remainder of points in the point cloud;
calculating a set of points that describes an actual reflective surface from the mirrored points having been registered and the virtual points corresponding thereto using the law of reflection; and
updating parameters for the modeled reflective surface from the set of points that describes the actual reflective surface, thereby providing an accurate position and shape for the reflective surface in the point cloud.

2. The computer-implemented method of claim 1, wherein at least one of the registering, the identifying and removing, the calculating, and the updating are repeated to improve an accuracy.

3. The computer-implemented method of claim 1, wherein the mirrored points having been registered are utilized to make the point cloud denser.

4. The computer-implemented method of claim 1, wherein the mirrored points are utilized to add points that are not directly visible from the position of the device.

5. The computer-implemented method of claim 1, wherein the virtual points are removed from the point cloud.

6. The computer-implemented method of claim 1, wherein a failed registration is taken as a criterion to reject false positively detected mirror surfaces from other mirror detection methods.

7. The computer-implemented method of claim 1, wherein an artificial intelligence (AI) model is trained to determine the initial location of the modelled reflective surface.

8. A system comprising:
a memory having computer readable instructions; and
at least one processor for executing the computer readable instructions, the computer readable instructions controlling the at least one processor to perform operations comprising:
receiving an initial location for a modeled reflective surface in a point cloud of an environment and information from which coordinates of points of the point cloud were captured by a device;
dividing the point cloud into two parts comprising (i) virtual points that are behind the modeled reflective surface with respect to a position from where the points were recorded, and (ii) a remainder of points;
generating mirrored points by applying a law of reflection to the virtual points with respect to the modeled reflective surface and the position from where the points were recorded;
registering the mirrored points to the remainder of points in the point cloud;
identifying and removing the mirrored points that do not align with the remainder of points in the point cloud;
calculating a set of points that describes an actual reflective surface from the mirrored points having been registered and the virtual points corresponding thereto using the law of reflection; and
updating parameters for the modeled reflective surface from the set of points that describes the actual reflective surface, thereby providing an accurate position and shape for the reflective surface in the point cloud.

9. The system of claim 8, wherein at least one of the registering, the identifying and removing, the calculating, and the updating are repeated to improve an accuracy.

10. The system of claim 8, wherein the mirrored points are utilized to make the point cloud denser.

11. The system of claim 8, wherein the mirrored points are utilized to add points that are not directly visible from the position of the device.

12. The system of claim 8, wherein the virtual points are removed from the point cloud.

13. The system of claim 8, wherein a failed registration is taken as a criterion to reject false positively detected mirror surfaces from other mirror detection methods.

14. The system of claim 8, wherein an artificial intelligence (AI) model is trained to determine the initial location of the modelled reflective surface.

15. A computer program product comprising a computer readable storage medium having program instructions embodied therewith, the program instructions executable by at least one processor to cause the at least one processor to perform operations comprising:
receiving an initial location for a modeled reflective surface in a point cloud of an environment and information from which coordinates of points of the point cloud were captured by a device;
dividing the point cloud into two parts comprising virtual points that are behind the modeled reflective surface with respect to a position from where the points were recorded, and a remainder of points;
generating mirrored points by applying a law of reflection to the virtual points with respect to the modeled reflective surface and the position from where the points were recorded;
registering the mirrored points to the remainder of points in the point cloud;
identifying and removing the mirrored points that do not align with the rest of the points in the point cloud;
calculating a set of points that describes an actual reflective surface from the mirrored points having been registered and the virtual points corresponding thereto using the law of reflection; and
updating parameters for the modeled reflective surface from the set of points that describes the actual reflective surface, thereby providing an accurate position and shape for the reflective surface in the point cloud.

16. The computer program product of claim 15, wherein at least one of the registering, the identifying and removing, the calculating, and the updating are repeated to improve an accuracy.

17. The computer program product of claim 15, wherein the mirrored points are utilized to make the point cloud denser.

18. The computer program product of claim 15, wherein the mirrored points are utilized to add points that are not directly visible from the position of the device.

19. The computer program product of claim 15, wherein the virtual points are removed from the point cloud.

20. The computer program product of claim 15, wherein a failed registration is taken as a criterion to reject false positively detected mirror surfaces from other mirror detection methods.
